(19) United States
(12) Patent Application Publication
(10) Pub. No.: US 2016/0221816 A1
(43) Pub. Date: Aug. 4, 2016

(54) Vehicle Data and Fuel Management System

(71) Applicants: Stephen F Pollock, Valparaiso, FL (US); Mark Butsch, Valparaiso, FL (US); Chris Leith, Valparaiso, FL (US); James Fuson, Valparaiso, FL (US)

(72) Inventors: Stephen F Pollock, Valparaiso, FL (US); Mark Butsch, Valparaiso, FL (US); Chris Leith, Valparaiso, FL (US); James Fuson, Valparaiso, FL (US)

(21) Appl. No.: 14/612,379

(22) Filed: Feb. 3, 2015

(51) Int. Cl. B67D 7/04; G05B 15/02; G06K 7/10

(52) U.S. Cl. CPC B67D 7/04; G06K 7/10366; G05B 15/02

(57) ABSTRACT

A system and method for automating dispensing operations such as vehicle fueling operations. The system properly matches a dispenser to a port on a specific container, thereby insuring that the proper substance is loaded into the proper container. A passive or active RF/ID module is attached to the dispenser assembly. A fuel port antenna located on the container's port is used to communicated with this RF/ID module. The fuel port antenna's driving circuitry is able to step through multiple frequencies within a defined frequency band. A suitable transmission frequency is determined and stored in memory. A container-specific frequency is thereby determined and stored for future use. The use of this optimized frequency serves the dual purposes of maintaining only a short-range R/F link while also ensuring the reliability of that link.

### BACKGROUND OF THE INVENTION

1. Field of the Invention

This invention relates to the field of vehicle data management and fueling control. More specifically, the invention comprises a system and method for automating vehicle data acquisition and fueling control for a fleet of vehicles. The system and method are suitable for controlling, authorizing and accounting for fuel dispensed from fuel dispensers without requiring control and authorization input from individuals performing the fueling. In addition, the system autonomously collects data from the vehicle being fueled. The disclosed system and method is intended primarily for use in the distribution of liquid and gaseous fuels. However, the system and method may be applied to virtually any product that can be autonomously counted and controlled.

2. Description of the Related Art

Solid state microcontroller-based fuel control and accounting systems have been commercially available since the early 1980s. The known systems have incorporated many methods of accessing and transferring authorization data, including the use of read-only electronic keys, read/write electronic keys, keypad entry, read-only radio frequency (“RF”) identification (“ID”) tags, read/write RF/ID tags, magnetic stripe cards, bar code readers, biometrics and inductive coil antenna. Hardware and Software supporting these types of access features are presently available from a large number of commercial companies.

Each of the known systems has disadvantages. The one common disadvantage of most of the systems is the inability to automatically positively identify the vehicle being fueled. This leaves open the possibility of a user initiating fueling for an authorized vehicle, but then actually pumping the fuel into an unauthorized vehicle.

RF/ID tags can be used to automatically identify objects over relatively short distances. These devices may have varying attributes, including short-range and long-range capability, internal power versus external power, and active versus passive operation. Externally-powered RF/ID tags receive electrical energy through an inductive coupling. A “power antenna” on an external device is used to transfer energy to an antenna in the RF/ID tag (a data signal may be included in the power signal as well). An internally-powered RF/ID tag typically has a battery. The battery is often not rechargeable or replaceable. However, because an RF/ID tag consumes a small amount of energy in its operation and has a limited service life, it is often possible to provide a battery that will last the service life of the device (such as a 3-year battery).

The active versus passive distinction for an RF/ID tag relates to its interrogation and response cycle. A “passive” RF/ID tag will generally respond to interrogation by modulating the carrier wave used (via inductive coupling) to power the tag. In general a passive tag uses a damping (load) resistor on the secondary coil to produce a loading effect on the primary coil belonging to the reader. The reader can sense the slight drop in voltage that results from this loading. Thus, the damping resistor is able to modulate the carrier wave from the reader. This effect is referred to as load modulation. The response of a passive RF/ID tag is therefore fixed.

Active RF/ID tags, on the other hand, are capable of responding on their own carrier waves and/or with their own coded signal and/or data. The coded response signal may be varied according to information available to the active RF/ID tag. It is common to provide such active RF/ID tags with an internal power source (such as a battery). Because the response signal may be amplified, active RF/ID tags may usually communicate over longer ranges than passive tags.

The active/passive attribute should not be confused with the internal power/external power attribute. There are, for example, powered passive tags where the internal power source is used only to increase a passive RF/ID tag's range. Short-range RF/ID tags generally have very short-range operational characteristics that assure that only one RF/ID tag responds to a signal sent by a querying device. In some cases this feature is advantageous. If for instance one wishes to insure that a querying device on a vehicle fuel filler port can only “talk to” an RF/ID tag that is mounted on a fueling nozzle placed in the filler port, it is advantageous to use a short-range RF/ID tag placed on the fuel nozzle.

On the other hand, long-range RF/ID tags are often able to communicate more reliably. If they are used in the fueling scenario, however, many RF/ID tags within the range of a querying device located on a vehicle fuel filler port may respond. In this case it is desirable to provide additional information to positively identify a specific RF/ID tag.

Many vehicles now incorporate an Onboard Diagnostic Bus (OBD Bus). The OBD bus uses defined protocols to transmit and retrieve information between a vehicle's on-board computers. Data transmitted on the OBD bus includes odometer readings, vehicle speed information, and engine management information. For this disclosed system “OBD Bus” will be used to refer to any vehicle communication bus that transmits data pertaining to the vehicle's current or past state. Exemplary OBD busses include the OBD II, EOBD, JOBD, J1708, J1939, and ISO 9141 bus standards.

The vehicle's on-board computers are used to operate, monitor, and maintain the vehicle. The early OBD busses were mandated by governmental entities to provide a standardized way for automotive diagnostic tool manufactures to interface with the on-board computers. They were primarily intended to aid in the diagnosis and repair of defects. Automotive diagnostic tools now have access to the standardized OBD Bus via a connector referred to as the “OBD Port.” Prior art diagnostic tools must be physically connected to an automotive diagnostic port in order to acquire information from the OBD Bus. This usually occurs only after the vehicle has problems. The OBD Port is not typically used for preventative maintenance.

U.S. Pat. No. 6,618,362 to Terranova discloses a transponder that acts as a replacement for the wire connection at the OBD Port, but does nothing towards implementing a pro-active vehicle maintenance system. In order to implement a truly autonomous preventative maintenance method an autonomous method of vehicle information download is preferred. The present invention implements a truly autonomous preventative maintenance method by autonomously downloading vehicle maintenance information each time a vehicle comes within RF range of a receiver. Via this method a vehicle's on-board maintenance record is autonomously downloaded at each fueling and or entrance or exit from a given facility.

The prior art access and fueling device have generally been located in one of four places. These are: a fuel dispenser, an island-mounted process and control unit, a vehicle-mounted processing unit, and a computer located in an accounting office. Communication between these components follows a defined path from component to component. In any of these cases the system's overall reliability and accuracy is a function of the reliability and accuracy of the system's individual components. In no case is the system's overall reliability and accuracy better than the weakest link in the system and is usually much less than the weakest link's.

In response to the need for greater reliability and flexibility the preferred embodiment of the disclosed system redefines prior physical, electronic, code and conceptual concepts into modules whereby any and all modules are in communications with any and all other modules and whereby any series of modules can provide for the functionality of any and all modules that are either non-functional or overloaded. The proposed module-to-module interconnectivity increases the seed and reliability of the system as a whole.

U.S. Pat. No. 5,923,572 to Pollock of Syn-Tech Systems, Inc. discloses an apparatus for system control, authorization and accounting for liquid petroleum fuel dispensed from liquid petroleum fuel dispensers without the need for control and authorization input from individuals performing the fueling. The system comprises an RF/ID tag mounted on the fuel nozzle, an Automotive Information Module mounted in the vehicle, a fuel island-mounted Fuel Management Unit and central controller software which provides the system owner with fuel usage and invoicing reports. The present invention expands upon and improves the concepts disclosed in the Pollock '572 patent.

### BRIEF SUMMARY OF THE PRESENT INVENTION

The disclosed system controls, authorizes and accounts for dispensed products without the need for control and authorization input from individuals performing the fueling. Although the discussion of the preferred embodiments focuses on the dispensing of liquid fuels, gaseous and electric refueling systems are equally suited for the disclosed system.

The invention uses a radio frequency identification tag (“RF/ID”) mounted on the fuel dispensing device. An Automotive Information Module (“AIM”) is mounted on the vehicle (Note that although the term “automotive” is used in the name of the AIM it is by no means limited to automobiles and may be mounted on virtually any type of vehicle—including trucks, boats, and aircraft). The AIM is connected to a communication antenna located near the vehicle's fuel port. The antenna is used to transit a query signal for the AIM.

When a fuel dispensing device is placed in the vehicle's fuel port, the RF/ID tag on the dispensing device receives the query signal from the vehicle-mounted AIM and responds to it. The RF/ID tag on the dispenser provides the Automotive Information Module (AIM) mounted in the vehicle with dispenser identification information and acts as the fueling sequence initiator. Further, the limited short-range coupling between the RF/ID tag and the AIM's fuel port mounted antenna provides security against the misappropriation of fuel (Fuel may only be dispensed while the communication antenna continues to receive responses from the RF/ID tag on the dispenser).

Once the AIM verifies the presence of the RF/ID tag, it transmits a signal to a pump control module associated with the fuel dispensing machinery. The communication between the pump control module and the AIM allows the system to determine that an appropriate fuel dispensing device has been connected to an appropriate vehicle. Fueling is then allowed.

In addition, the AIM preferably transmits selected vehicle data to the pump control module or other collection point. The transmitted vehicle data may include vehicle mileage, selected engine performance parameters, and selected maintenance cues. All this information may be gathered by the pump control module and relayed on to a remote collection point.

The reader will appreciate that a significant component of the current invention is the radio frequency communication between the AIM and the RF/ID tag mounted on a dispensing device. The antenna connected to the AIM must transmit signals to the RF/ID tag and receive signals back from that tag. It is anticipated that the AIM and the associated antenna will be mounted on a wide variety of vehicles. Some vehicles will have a large mass of ferromagnetic material (steel) near the fuel filler port. Other vehicles—being made of aluminum, composites, or other non-magnetic material—may have very little ferromagnetic material near the filler port. The transmitter associated with the AIM is typically some kind of LC circuit. Ferromagnetic material near the antenna tends to inductively couple with the antenna and shift either or both of the transmitted or received signals. Other interfering phenomena may also shift the frequencies.

To account for this variation in inductance, the AIM transmitter preferably includes a frequency-adjusting feature. In seeking to make contact with the RF/ID module on the fuel dispensing device, the frequency-adjusting feature changes the transmitted frequency until a good communication link is established. The AIM module preferably stores the frequency information so that, in the future, it can start the query process with a “known good” frequency. In this manner, the AIM module can optimize itself for the particular vehicle in which it is installed.

### BRIEF DESCRIPTION OF THE SEVERAL VIEWS OF THE DRAWINGS

FIG. 1 is a perspective view, showing a fueling station incorporating the present inventive system installed on a fueling island with an electronic dispenser.

FIG. 2 is a perspective view, showing another type of fueling station incorporating the present inventive system installed on a fueling island with a Fuel Management Unit and a mechanical dispenser.

FIG. 3 is a perspective view, showing some of the exemplary communication and data gathering components used in the present invention as installed on a vehicle and a dispenser nozzle.

FIG. 4 is a block diagram, showing the interconnectivity of the various components of one embodiment using wired or wireless connections.

FIG. 5 is a block diagram, showing how a pump control module may be used to control a mechanical fuel dispenser in a preferred embodiment of the invention.

FIG. 6 is a block diagram, showing an electronic fuel dispenser and its interface with a pump control module in a preferred embodiment of the invention.

FIG. 7 is a block diagram, showing an exemplary pump control module configured to interface with a mechanical fuel dispenser.

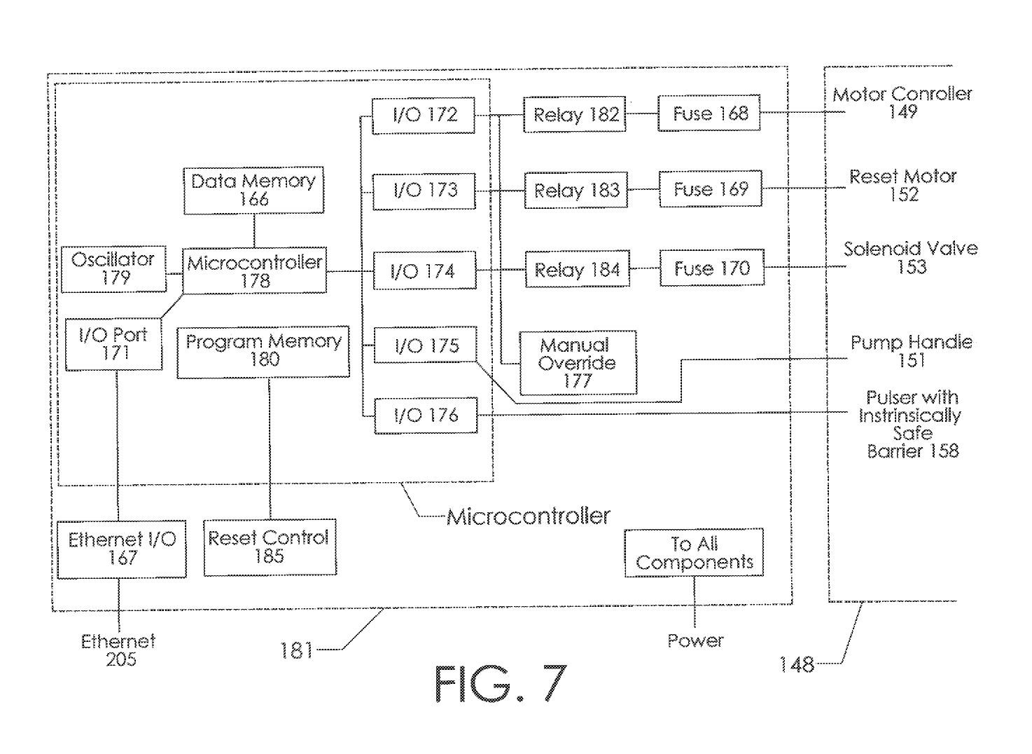

FIG. 8 is a block diagram, showing a pump control module and its interface with an electrical fuel dispenser.

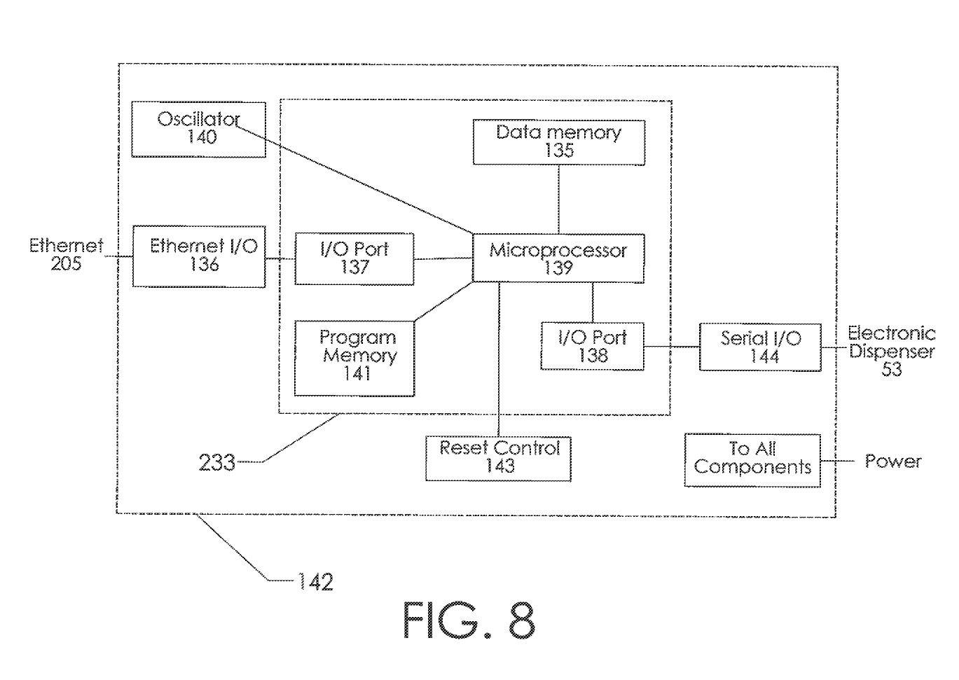

FIG. 9 is a block diagram, showing an exemplary interconnection and flow of control and data within an RF/ID tag in accordance with the invention.

FIG. 10 is a block diagram, showing exemplary interconnections and the flow of control and data within an Automotive Information Module in a preferred embodiment of the invention.

FIG. 11 is a block diagram, illustrating the interconnections and the flow of control and data within an exemplary Fuel Management Unit (“FMU”) in accordance with a preferred embodiment of the invention.

FIG. 12 is a block diagram, illustrating the interconnections and the flow of control and data within an AIM transceiver module.

FIG. 13 is a block diagram, showing the inclusion of a transmitter capable of sending more than one frequency.

FIG. 14 is a flow chart, showing an exemplary process that may be used with the variable frequency transmitter.

### REFERENCE NUMERALS IN THE DRAWINGS

2 amplifier and comparator connector
3 RF/ID tag reader integrated circuit
4 data memory
5 transceiver integrated circuit
6 I/O port
7 GPS module
8 I/O port
9 I/O processor
10 I/O port
11 I/O port
12 I/O port
13 I/O port
14 I/O port
15 capacitor switching network
16 intrinsically safe barrier
17 level converter
18 microcontroller
19 mileage interface
20 OBD connector
21 external data memory
22 oscillator
23 power antenna
26 intrinsically safe barrier
27 program memory
28 programming interface
29 reset control
30 microcontroller
32 RF/ID interrogator
33 +5V voltage regulator
34 +8V voltage regulator
37 AIM transceiver module
40 transceiver integrated circuit
41 Ethernet I/O
44 microcontroller
46 program memory
52 dispenser computer
53 electronic fuel dispenser
54 intrinsically safe barrier
55 meter
56 motor controller
57 pulser
58 pump
59 pump motor
60 register
61 reset motor
62 serial interface
63 solenoid valve
64 pump handle
68 battery
70 data memory
71 Ethernet interface
72 Fuel Management Unit
73 keypad interface
75 LCD control
76 level converter
77 level converter
78 level converter
79 level converter
80 processor
81 modem
82 multiplexer
83 on-site printer interface
84 oscillator
85 power supply
86 powerfail detect
87 program memory
88 programming interface
89 RAM
90 read/write access device
91 receipt printer interface
92 reset control
93 serial port
94 serial port
95 serial port
96 serial port
97 serial port
98 tank level monitor interface
100 Automotive Information Module
101 fuel nozzle
102 fuel island
103 vehicle
105 fuel port
106 fuel port antenna
107 OBD port
110 GPS antenna
111 cell phone antenna
135 data memory
136 Ethernet I/O
137 I/O port
138 I/O port
139 microprocessor
140 oscillator
141 program memory
142 Pump Control Module
143 reset control
144 serial port
148 mechanical dispenser
149 motor controller
150 pulser
151 pump handle
152 motor reset
153 solenoid valve
154 pump
155 motor
156 meter
157 register
158 intrinsically safe barrier
166 data memory
167 Ethernet I/C
168 fuse
169 fuse
170 fuse
171 I/O port
172 I/O
173 I/O
174 I/O
175 I/O
176 I/O
177 manual override
178 microprocessor
179 oscillator
180 program memory
181 Pump Control Module
182 relay
183 relay
184 relay
185 reset control
190 coil interface
192 capacitor
194 microcontroller
196 memory
199 microcontroller
201 RF/ID tag
203 RF/ID tag antenna
205 Ethernet
210 frequency switching transmitter
212 microcontroller
214 controlled switch bank
216 oscillator
218 transistor
220 signal trigger
222 fixed frequency circuit
224 frequency retrieval step
226 frequency transmission step
228 reply query step
230 program memory
231 frequency storage step
232 frequency increment step
233 processor
234 microcontroller

### DETAILED DESCRIPTION

Practically innumerable embodiments of the present invention are possible. The following descriptions provide details regarding a few of these embodiments. The descriptions pertain to road-going vehicles such as automobiles and trucks. However, the reader should bear in mind that the invention may be adapted for use with other types of vehicles, including aircraft and ships. As stated previously, some of the component names suggest that the inventive system is limited to road-going vehicles (the term “Automotive” being one example). However, the use of this type of name should not be viewed as limiting. Those skilled in the art will realize that a component such as the Automotive Information Module (“AIM”) may easily be adapted for use in an aircraft. Different parameters may be used (such as flight time versus road mileage) but the functions will generally be the same.

A description of the invention's application to road-going vehicles provides a good basis for the reader's understanding. In general, the Automotive Information Module (AIM) mounted in the vehicle interfaces with the vehicle's on-board computer system or directly to the vehicle's mileage pickup, the fuel dispenser-mounted RF/ID tag and the fuel island-mounted Fuel Management Unit. With these interfaces the Automotive Information Module is able to transfer data and operational commands within the disclosed system.

A typical installation of the inventive system may include:
a. Radio frequency identification tags (RF/ID tags) mounted on liquid or gaseous petroleum dispensing nozzles,
b. Vehicle-mounted Automotive Information Modules (AIM),
c. AIM transceiver modules,
d. Pump Control Modules,
e. Fuel island-mounted Fuel Management Units (FMU),
f. On-site or remotely-located site controller s,
g. On-site or remotely-located site controller software packages,
h. On-site or remotely-located central controller software packages,
i. On-site or remotely-located databases, and
j. On-site or remotely-located computing devices.

The aforementioned components communicate via wired or wireless protocols. Exemplary protocols include Ethernet, BLUETOOTH, ZIGBEE, and LAN (local) or WAN (wide area) networking protocols. Since software packages can be run on any platform and network communications allow physical components to be located almost anywhere, the actual physical location and numbers of components will be determined by each specific application. As such there can be physically many of the aforementioned components or only a few such components.

On-site or remotely-located software is preferably used for configuring and storing site information, processing and storing lock-in and lock-out authentication data and lists, and reporting and invoicing for fueling transaction data. Henceforth, the on-site or remotely-located software will be referred to as “central controller software.” In addition to the central controller software there is preferably also provided site controller software. In the preferred embodiments of the disclosed system the site controller software's function is local control of a fueling site via control of system modules. The location of the computing device actually running the site controller software is as with central controller software immaterial to its intended purpose. However, in a typical embodiment of the disclosed system the site controller software will be running on a Fuel Management Unit's microcontroller-based platform or on an independent microcontroller based platform. The independent microprocessor based platform would be referred to an on-site or remotely-located site controller.

Radio frequency identification tag(s) (RF/ID tag) mounted on the liquid and or gaseous petroleum products nozzle(s) provide the Automotive Information Module (AIM) mounted in the vehicle with information uniquely identifying the particular dispenser nozzle that has been placed in the vehicle's fueling port. The communication link between the AIM and the RF/ID tag on the nozzle acts as the fueling sequence initiator. The fact that the RF/ID tag must be very close to the AIM's fuel port antenna prevents the deliberate misappropriation of fuel. In the preferred embodiments, fueling can only continue while the RF/ID tag's presence continues to be sensed. Thus, an operator cannot initiate the fueling sequence by placing a nozzle in an approved vehicle's fuel port, and then deliver the fuel to another vehicle by transferring the nozzle.

The Automotive Information Module (AIM) mounted in the vehicle interfaces with the vehicle's on-board computer system or directly to the vehicle's mileage pickup or other sensors. The AIM communicates with the nozzle-mounted radio frequency identification tag using a short-range coupling antenna located on the fuel port. The AIM also communicates with a fuel island-mounted Fuel Management Unit using a longer-range R/F transceiver. Using these communication links, the AIM is able to transfer data and commands.

AIM transceiver module(s) with wired or wireless communication links can be mounted in any convenient location in the vicinity of the fuel island. Such AIM transceiver module(s) provide wireless access for data flow from and to the vehicle mounted Automotive Information Module (AIM) and via said AIM to the vehicle's OBD Bus for vehicle specific information.

Pump Control Module(s) with wired or wireless communication links may be mounted on the fuel pump or dispenser. These components provide direct interface with and control of the individual fuel dispensers and provide wireless access for control and for data flow to and from the central controller software.

The central controller software with wired or wireless communication access provides the system owners, operators and users raw data, analyzed data and reports based on accumulated data from the Automotive Information Modules (via the AIM transceiver module(s)) and the fuel dispenser (via the Pump Control Module(s)). With these controls and interfaces the present invention provides means of both autonomous operation and directed data processing between all components.

An RF/ID tag is preferably mounted on each individual fuel dispenser nozzle of the fuel supply source. Each RF/ID tag preferably has a specific ID unique to the fuel site and to the fuel dispenser nozzle. Upon insertion of the fuel dispenser nozzle into the vehicle's fuel port, the Automotive Information Module microcontroller and RF/ID tag interrogation circuitry and antenna read (interrogate) the RF/ID tag. The RF/ID tag's specific ID, AIM stored data (including at least the following: vehicle ID; fuel supply source signature, herein “Customer ID”; fuel types; and quantity limits) and the current vehicle mileage and/or hours are then transmitted by the AIM to the AIM transceiver module via the AIM's RF transmitter.

The AIM transceiver module transfers data between AIM(s) and the site controller software. The site controller software then correlates the received data with the site controller software's internally-stored RF/ID tag and fuel dispensing hose correlation data with the Fuel Management Unit's lock-in and lock-out data and, if the data meets all acceptance criteria, the site controller software allows the fuel dispenser to dispense fuel via communication with the appropriated Pump Control Module. The Pump Control Module is in communication with and/or in control of the specific hose which needs to be activated.

The RF/ID tag can be a specially designed or a commercially available read-only or read-write short-range tag. The RF/ID tag's short-range is an important advantage with respect to overall system functionality, in that only when the fuel nozzle is inserted into the vehicle's fuel port is the RF/ID tag within range of the vehicle's AIM RF/ID tag antenna. Accordingly, only under conditions for fueling, can the RF/ID tag be read or interrogated so that fueling authorization can occur.

The RF/ID tag and the AIM antenna positional relationship also enables continuous security checking of the positional relationship, thereby allowing the FMU to terminate fueling once the nozzle is removed from the fuel port.

The AIM achieves these functional fueling related tasks of reading (interrogation) of the RF/ID tag, RF transmission of data (preferably including at least the following: RF/ID tag ID, vehicle specific data and current vehicle mileage and/or hours), and interfacing with the vehicle's on-board computers via the Onboard Diagnostic Bus (OBD Bus).

The reading of RF/ID tags is accomplished via the AIM's microcontroller, RF/ID tag interrogation circuitry, and antenna. This reading is accomplished upon initial insertion of the nozzle into the fuel port and, after initial insertion, and at continual intervals until the nozzle is removed. By this method, the AIM continuously monitors the presence of the RF/ID tags. The AIM is capable of reading multiple RF/ID tags and via this capability vehicles with multiple tanks can be refueled via multiple RF/ID tag equipped hoses.

In an aforementioned authorization scenario communication goes from the AIM to the AIM transceiver module to the site controller software to the Pump Control Module and on to the dispenser via either direct control or a communications protocol wherein each of said communications was a 2-way protocol. In the prior paragraph discussing the advantages of the short range RF/ID tag interrogation scenario, the authorization scenario gets shortened by implementing direct communication between the AIM transceiver module and the Pump Control Module. Via this scenario volume of communication traffic is reduced as are time requirements. Upon completion of a fueling transaction the Pump Control Module will communicate fueling data to the site controller software for storage and appropriate data dissemination.

The Onboard Diagnostic Bus (OBD Bus) on a particular vehicle uses a defined protocol to transmit and retrieve information between a vehicle's on-board computers. These on-board computers are used to operate, monitor, and maintain the automobile. They may also be used for component-to-component communication within the vehicle. The OBD Bus was mandated by various governmental authorities initially to provide a standardized way for automotive diagnostic tool manufactures to interface with, report malfunctions, and help diagnose problems in the modem automobile and truck. These automotive diagnostic tools have access to this standardized OBD Bus via a connector referred to as the OBD port. The AIM preferably connects to the OBD port in the same way. This communication allows the AIM to acquire the vehicle's mileage, acquire preventative maintenance data, and send commands to the vehicle's computers.

The AIM's interface with the vehicle's speedometer/odometer and/or chronometer can be accomplished via the OBD Port with newer vehicles. In non-OBD equipped vehicles this interface is accomplished by directly monitoring the vehicle's electronic speedometer/odometer circuitry, via a transducer in the vehicle's mechanical speedometer/odometer drive cable, or inclusion of and subsequent monitoring of an inductive pickup on the vehicle's drive shaft. The chronometer interface can be accomplished via monitoring of the vehicle's chronometer circuitry or via additional hardware built to supply the time data.

The processing, logic, and management of the functional tasks of the AIM are accomplished by the AIM's on-board microcontroller. The microcontroller provides for the storage of a vehicle's fuel requirements and vehicle specific data. It may also store and process vehicle-gathered data such as that acquired via the vehicle's OBD port. In addition, the on-board microcontroller may execute an active preventative maintenance program via gathering data on the vehicle's OBD port and comparing that data against a pre-programmed maintenance plan.

The microcontroller allows the AIM to receive vehicle specific data from an external source as well. It can also recognize the presence of the RF/ID tag on the fuel nozzle and transmit data appropriate to its presence or non-presence, and control its own startup and shutdown sequences.

The AIM uses bi-directional RF transmission to transfer data including RF/ID tag specific data, vehicle and fuel requirements specific data, and OBD port gathered vehicle specific data to the Site controller software via the AIM transceiver module (recall that the AIM transceiver module is located near the fueling point, such as on a fueling island at a service station). The site controller software's microcontroller(s) will compare the received fueling specific data and RF/ID tag data with the site controller software's stored lock-in and lock-out data lists so that authorization of fuel delivery can be undertaken. Data received from the vehicle's computers via the OBD port and or the AIM will be processed at the site controller software for transfer to a control and data transfer software program for use in an active or passive preventative maintenance program.

The site controller software authorizes fueling operations via direct control of mechanical fuel dispensers or via serial or other industry standard communications with electronic fuel dispensers (typically using Pump Control Modules). Upon fueling authorization, a particular Pump Control Module monitors the amount of fuel delivery (such as by monitoring the pulse output of a flow sensor) and fueling completion. For mechanical pumps and dispensers a Pump Control Module directly monitors the pulse count and for electronic dispensers the Pump Control Module receives count information from the dispenser's electronics. An AIM transceiver module in communication with the Pump Control Module is also capable of limiting and/or terminating fueling transactions. Upon fueling completion or upon reaching maximum quantity limits, the Pump Control Module terminates the fueling operation via control over the fuel dispenser and records a transaction. The transaction preferably includes at least the following information: data received via RF transmission from the AIM via AIM transceiver module(s); fuel quantity information (acquired from pulses equating to fuel quantity dispensed or directly via a serial connection to an electronic dispenser); and the FMU-configured data to include at least the time, date, fuel type and hose number.

The preferred embodiments preferably deny the issuance of fuel if the fuel nozzle is not within the receiving range of the short-range communications and data transfer devices. This feature combined with the verification requirement that all RF/ID tag data, AIM specific data, and FMU stored data be correct defines which vehicle(s) receive(s) fuel, thereby alleviating the two most common fuel control and accounting system errors of human error and theft.

The preferred embodiments also preferably feature a high level of automation to reduce the required operator input to a minimum. These features significantly reduce operator training and educational requirements, which results in a cost saving to customers in addition to those normally associated with fuel conservation, security and efficient accounting practices.

System security is preferably also enhanced by the incorporation of both a site-dependent and hose-dependent digital code encrypted into the AIM and the RF/ID tag, respectively. Via this means of fuel authorization, RF conflicts and data conflicts between hoses, sites, and transactions are eliminated, thereby eliminating potential errors which could otherwise occur when multiple fueling operations are occurring simultaneously at different hoses located at either the same or different fueling sites within the RF reception range of a given RF transceiver set.

A microcontroller-based computer is preferably provided in the Fuel Management Unit (“FMU”) to allow the system to interface with future technologies (and particularly future communication technologies) as they become commercially available. Future technologies may include biometric-based user verification, advanced versions of RF/ID tags, and governmental requirements for technical implementations of standards. Due to the system's flexibility, it is contemplated that these products and technical implementations of standards can be instituted within the capabilities of the invention.

Some embodiments will be configured for incorporation into existing fueling systems. Some existing systems have positive features which are responsible for their widespread acceptance and use. Positive features include the ability to: (1) provide security at a fueling site without requiring an on-site attendant; (2) accurately monitor the use of fuel; (3) provide reports for fuel usage; and (4) issue invoices for fuel usage.

The known systems have had problems associated with operator input errors and fuel theft by individuals with authorized access to the fueling site (for example, individuals having codes, keys, or cards for an authorized vehicle enabling system access to fuel an unauthorized vehicle). The disclosed system can be installed in new or existing fuel control and accounting systems, in order to negate the negative features present at existing sites. In addition, due to customer familiarity with existing systems, there exists the potential for customer reluctance to purchase fuel control and accounting systems. The disclosed system's enhancements over existing systems serve to mitigate any potential customer reluctance.

The inventive system minimizes equipment installation time. In current systems, entities serving the function of the disclosed system's AIM require programming, vehicle data inputs, and AIM data inputs. In the disclosed system the AIM can collect all the information needed from the computers on-board the vehicle's OBD Bus and from a site controller software database via their bi-directional RF communication capability with AIM transceiver modules. With the inventive system the AIM needs only be to physically installed, the vehicle driven within range of an AIM transceiver module, and an FMU instructed to set up the AIM's authorized products and electronic signature for the AIM to be initialized and ready for operation. Authorized products and electronic signatures are autonomously obtained via the FMU's communication connection and either a central or distributed database.

As mentioned previously, the inventive system is also able to carry out a program of autonomous and active preventative maintenance. Since the system's AIM interfaces with the computers on-board the vehicle's OBD Bus, has bi-directional RF communication capability with the FMU, and has a “smart on-board microcontroller”, the AIM can actively collect vehicle information data and autonomously pass this along to either a central or distributed database for subsequent use by central controller software. The central controller software can then export the collected data to fleet maintenance software programs. Since the collected data is both timely and accurate, it will often be possible to reduce fleet vehicle maintenance costs. The AIM is also capable of requesting that the vehicle's on-board computer display information on the vehicle's dash. For example the check engine light could be turned on to prompt the driver to return the vehicle for maintenance.

Radio frequency air time costs electrical power and may cause unwanted interference. The inventive system is designed to minimize RF air time, thereby maximizing communication efficiency. The AIM transceiver modules are able to control the amount of RF air time using the bi-directional RF communication capability of the system. Each AIM preferably only broadcasts in response to a request from an AIM transceiver module, and an AIM transceiver module may request only the specific data which it requires from the AIM. Via this method only one AIM will communicate at a time. In a similar scenario without bi-directional RF communication capability, each AIM would need to constantly broadcast all of its available information (vehicle information, current mileage, preventative maintenance information, etc. . . . ) because it could never be sure of exactly which information the AIM transceiver module required, and when the AIM transceiver module had received it correctly. This in turn uses much more air time and carries with it an associated increase in interference between the modules. In a scenario using simple transponders an AIM transceiver module would need to ask a series of questions of each AIM and each AIM would respond to each question in turn thus using much more air time with its associated increase in interference.

Software updates are often needed and it is desirable to automate the dissemination and installation of such updates. In the disclosed system firmware updates and feature selections to the FMUs, AIM transceiver modules, the Pump Control Modules and the AIMs themselves may be performed from the central controller software. This feature of the disclosed system is possible because of the internal update firmware of the FMUs, AIM transceiver modules, the Pump Control Modules and the AIMs, and the bi-directional communication capability of the components.

The inventive system preferably also includes a system for the autonomous tuning of the fuel port antenna loop and the nozzle mounted RF/ID tag antenna interface. The tuning of an antenna is typically controlled by the inductance/capacitance (L/C) characteristics of the antenna. The metal in a vehicle acts to change the L/C characteristics of the antenna circuit, which can cause each installation to be de-tuned (in an undesirable way). The disclosed system provides a Microcontroller and circuit-specific components that allow the AIM to autonomously tune every installation without the need for the assistance of an installer or a technician, or the need for parts and circuits specifically tuned for each vehicle and installation. Functionality is optimized and therefore inventory and installation man-hours are reduced. In PC jargon the installation becomes a ‘plug and play’ scenario.

The communication systems used in the present invention preferably also have the ability to select a frequency having the highest available signal to noise ratio. AIM transceiver modules will look for the quietest frequency on which to communicate with the AIMs. AIMs will look for the frequency on which the AIM transceiver modules are transmitting. Multiple AIM transceiver modules need not find the same frequency in order for a multiple dispenser, multiple AIM transceiver module, and multiple Pump Control Module site to function. All of the aforementioned items can be configured as nodes on a common network and as such have the capability to use data and information from any other node. Functionally this means that regardless of which AIM transceiver module to AIM-equipped vehicle communication is established, the AIM-equipped vehicle can fuel at any dispenser equipped with a Pump Control Module which resides as a node on the common network.

The system preferably prioritizes the RF messages. This functionality is possible because of the disclosed system's AIM transceiver module's microcontroller control and bi-directional RF communication capability. Messages necessary for control of primary system functions (e.g. fueling) are requested and transmitted more often than messages which are associated with secondary systems functions (e.g. preventative maintenance or firmware updates).

Each AIM is also preferably equipped with a powerfail data save capability. Via said capability and the accompanying circuitry the AIM is able to detect an impending powerfail and then store important data to non-volatile memory before power is lost. Active operating instructions and in-process data are also saved so that they may be continued when power is again made available. The active operating instructions and in-process data include information such as the current odometer and/or chronometers, speed sensor pulse count, the odometer and any firmware update progresses. The benefits of the AIM's powerfail data save capability include:
a. The AIM may be removed from the vehicle at any time without losing what is stored in memory;
b. No internal battery is required (separate from the vehicle battery);
c. The AIM is able to retain data during low voltage conditions which may occur during normal operation (such as when trying to start the vehicle); and,
d. No odometer or chronometer data is lost.

The AIM's on-board microcontroller is preferably also capable of receiving data from a Global Positioning System (GPS) receiver. Additionally, upon receipt of said data the AIM's microcontroller is preferably able to process the data into vehicle tracking information. The processed data could provide the maximum vehicle speed and where it occurred, the longest period of time the vehicle was at rest both with and without the motor running and where such events occurred.

Some embodiments may be provided with the ability for one AIM to communicate directly with another AIM (as opposed to having to go through an external device like an AIM transceiver). Direct AIM-to-AIM communication provides an autonomous method of retrieving information from AIM-equipped vehicles which don't regularly drive within range of an FMU. For example, a road service vehicles such as a tractor used for roadside mowing may only be used sporadically and may not ever drive by an FMU. Other examples include mine vehicles and non-highway use construction equipment. The AIM within such vehicles may communicate directly with a second AIM contained in a normal road-going vehicle. This second AIM would then “dump” the data to an FMU.

As previously stated the AIM is preferably capable of autonomous updates whereby firmware updates and feature selections for the AIMs may be performed from the central controller software. This capability allows the central controller software operator to specify and direct a specific vehicle's AIM, or multiple vehicles' AIMs, to communicate with other specific vehicles for the purpose of gathering information and transferring said information to an FMU when the gathering vehicle comes within RP range of said FMU.

Each AIM is preferably equipped with an auxiliary communications port. Such a port allows an AIM's communications and features capability to be expanded to meet future and customer specific needs and interfaces. For example, police cars, emergency vehicles, fire trucks, and school buses are equipped with a multitude of job-specific electronic equipment. Via the AIM's auxiliary port future and customer-specific interfaces can be accommodated.

The AIM and AIM transceiver modules used are preferably also capable of autonomous independent operation as a gate activation, car wash access controller, area access controller, and security monitoring device and/or simply a monitor for vehicles entering or leaving a facility. AIM transceiver modules may be placed at sites other than fueling operations where vehicle-related data may need to be collected. An example of this would be access gates and or access points and areas where the vehicles would normally pass. Via said remotely collected vehicle data system operators will know of vehicle problems if they exist and can better plan and execute their maintenance plan. Anytime an AIM comes within RF range of an AIM transceiver module an initial communication protocol will be initiated. This initial information fulfills the requirements for the aforementioned autonomously activated gate, entrance security and or a simple facility monitoring scenario. Data from the AIM transceiver module can then be passed via Ethernet to processors and software capable of providing users with said autonomously activated gate, entrance security and or a simply facility monitoring information. In a preferred embodiment of the invention the disclosed equipment and operational scenario is centered on a fueling station. However, an autonomously activated gate, a security entrance, or a simple facility monitoring device can become an integral part of the embodiment.

Similar to the aforementioned autonomous independent operation as a gate activation, area access and security monitoring device would be an AIM's use as an autonomous area monitoring device. In this scenario, for example, AIM's installed on over-the-road refrigerated trucks and trailers, hereafter referred to as a reefers, can be used to monitor the reefer's internal temperature, door access, and fuel remaining in the reefer's fuel tank. In addition to these features, AIM reefer installations will still provide all other fuel control and account features and OBD data collection features previously disclosed. An AIM may also be used with generators and other motor-driven equipment such as oil-field exploration equipment.

It is preferable for each AIM transceiver module to be capable of autonomous independent operation as a Remote Data Collection Unit (RDCU). Each AIM transceiver module is capable of autonomous interrogation of AIM-equipped vehicles and as such AIM transceiver modules may be placed at sites other than fueling operations where vehicle-related data may need to be collected. An example of this would be a maintenance facility, an office parking lot, or any place where the vehicles that need monitoring congregate or would normally pass. Via said remotely collected vehicle data system, operators will know of vehicle problems if they exist and can better plan and execute their maintenance plan. Similarly, AIM's and AIM transceiver modules can be used as non-related entities or as integral parts of the preferred embodiment of this disclosure at maintenance facilities in order to ascertain which vehicles are present and which need maintenance. Such a determination can be accomplished using any remote computing device without the need to physically inspect each and every vehicle.

Similar to the AIM's ability to be used in conjunction with AIM transceiver modules to ascertain which vehicles are present and which need maintenance, a wireless smart phone or Personal Digital Assistant (PDAs) can be used for AIM interrogation. An application running on such a device can further run maintenance programs which in turn can be correlated to any problems presented via the vehicle's OBD Bus, an AIM and an AIM transceiver module.

Each AIM is preferably also able to track and record Power Take-Off (PTO) engine run time for vehicles or other equipment having a PTO. Via this recorded data, the Central controller software can provide taxable and non-taxable fuel usage data for vehicles which use the highways. When AIMs are placed on vehicles, which are considered off-road only vehicles, the Central controller software can also be used to separate this non-taxable fuel from taxable fuel used on over the road vehicles.

An AIM will preferably also include the ability to act as an autonomous credit card processor and an FMU is preferably capable of authorizing and processing the autonomous transaction though commercial banking networks, which includes means to load and store commercial credit card numbers and/or appropriate authorization data in an AIM or an FMU. This data is then used by the FMU and/or site controller software to authorize a transaction and to process the transaction data though commercial banking networks. Via this capability a fueling transaction becomes an autonomous operation whereby the user simply gets fuel and the user's credit card gets charged for the transaction.

All prior discussions and descriptions were limited to autonomous fueling operations via the vehicle-mounted AIM. This however is not by any means the only way to implement the present invention. Electronic keys, magnetic stripe cards, smart cards, keyboard entry, barcode and biometrics are common access devices that could be used (although maybe not all have found their way into the commercial fueling scenarios yet). Additionally, receipt prints, transaction printers, and tank level monitoring systems are also all in common use. As such all or any of these features and or devices could be integrated into the present invention via the Fuel Management Unit (FMU) and or site controller and site controller software.

The Fuel Management Unit (FMU) and or a site controller can also provide a backup and or secondary means of operation so that site operation is not solely dependent on the internet for communication nor is its operability solely dependent on remotely located site controller software. Implementation of the backup or secondary means of operation is provided by the Fuel Management Unit (FMU) or a site controller's ability to act a backup data source for the system's site controller software via distribution of functionality.

Under the currently prevailing technology it is preferable that the Fuel Management Unit (FMU) or a site controller (as with the other disclosed components of the invention) communicate via a network using Ethernet technology, where Ethernet represents a technology within LAN (local) or WAN (wide area) networking be it wired or wireless.

The following describes how a fuel authorization process might be carried out: Fuel may be authorized via the passive AIM scenario or via any of the interactive user devices such as an electronic key, smart card, and magnetic stripe card.
a. Via the passive AIM scenario, the AIM will send RF authorization data to an AIM transceiver module which in turn will send said authorization data to an FMU or site controller. The FMU or site controller will match the received authorization data with its internal lock-in and/or lock-out lists which includes but is not limited to the type of fuel authorized, Customer ID, allowable fuel quantities, and vehicle ID. If all the authorization criteria are met the FMU or site controller will forward the necessary authorization to the appropriate Pump Control Module. Fueling can then begin.
b. Via the interactive user device scenario, an FMU acquires authorization data directly via the access device. The FMU or site controller will match the received authorization data with its internal lock-in and/or lock-out lists which include but are not limited to the type of fuel authorized, Customer ID, allowable fuel quantities, and vehicle ID. If all the authorization criteria are met the FMU or site controller will prompt the user to select a hose whereupon the FMU will forward the necessary authorization to the appropriate Pump Control Module.
c. There is an additional interactive user device scenario, which authorizes via third party credit card networks. In this scenario, the most common user interface device is the magnetic strip credit card. Upon a card being read by an FMU's magnetic stripe credit card reader, the FMU contacts the appropriate third party credit card network for authorization, which includes but is not limited to an authorization number and an authorized dollar amount. Upon receiving the authorization and fuel type data, the data is forwarded to the appropriate Pump Control Module.
d. Whatever scenario is used, an authorization must be sent to the appropriate Pump Control Module. The Pump Control Module will initiate fueling by allowing the selected hose to dispense fuel via a valve, pump and/or pump handle control in the case of mechanical dispenser and via a serial interface with electronic dispensers. For mechanical dispensers the Pump Control Module will monitor the pulse count, which equates to quantity dispensed, terminate the dispensing upon reaching an authorized quantity limit, upon termination by the user or upon a preset non-activity period of time. When controlling an electronic dispenser the same functions are accomplished electronically versus the mechanical dispenser's direct control. Upon termination of the fueling transaction, the Pump Control Module will store the transaction data and send said transaction data to the FMU for storage and further processing.
e. The further processing will preferably include sending third party credit card authorized data back to the appropriate third party credit card network for further processing, and in the case of locally authorized electronic key, smart card, and magnetic stripe card transaction the transaction data will be sent to the central controller for further processing and distribution.

Some specific implementations will now be described with respect to the drawings provided. Again, these should not be viewed as limiting the scope of the invention but rather as explaining how the invention might be applied to meet the needs of a particular environment.

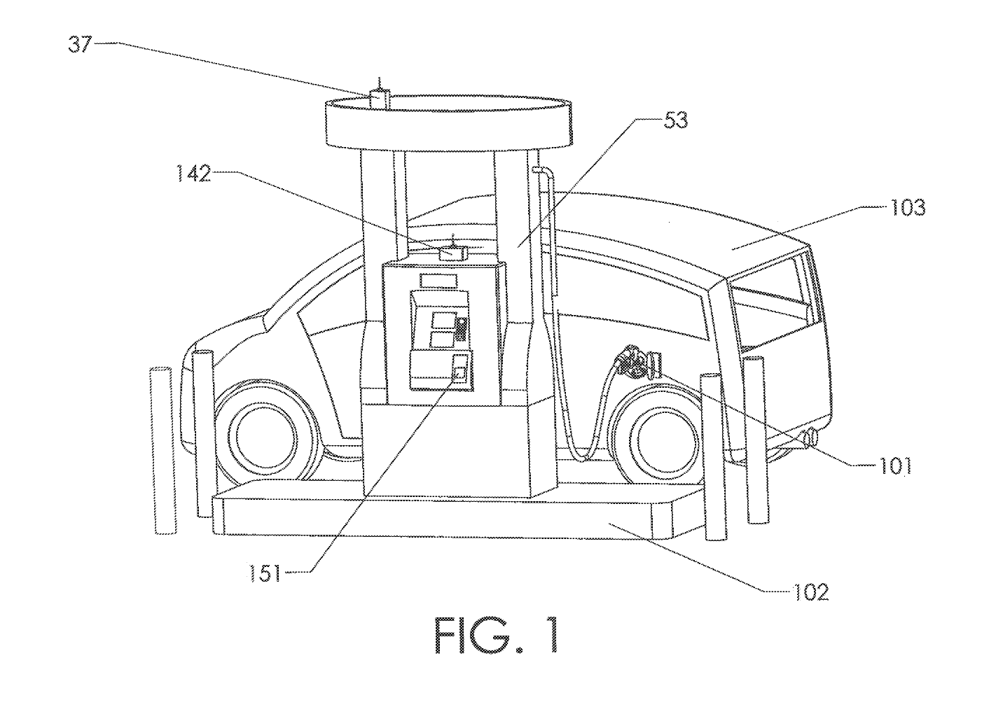

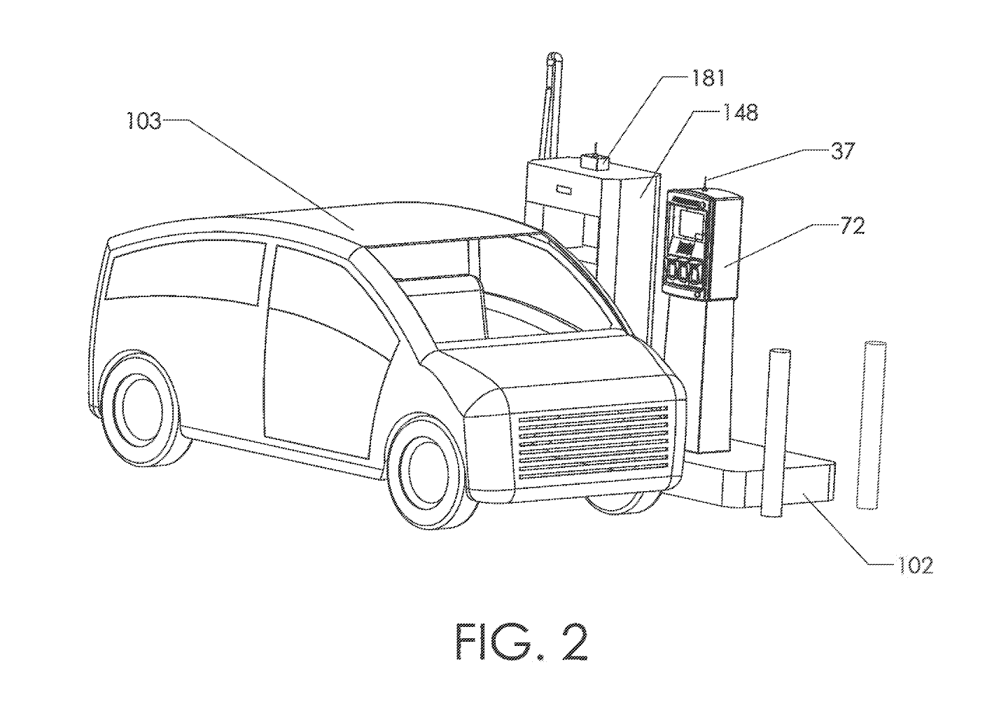

FIGS. 1-3 illustrate the components involved in a typical installation. FIG. 1 represents an installation for a public-use fueling station. FIG. 2 represents and installation that would be more typical for a fleet fueling installation that may not be open to the public. As will be seen, the use of the components is quite similar for either option and no component should be viewed as being limited to any particular option.

Returning now to FIG. 1, vehicle 103 has been pulled alongside fuel island 102. The vehicle includes an internal Automotive Information Module (“AIM”). Fuel nozzle 101 includes a mounted RF/ID tag that communicates with an antenna located proximate the vehicle's fuel port. The fuel port antenna is connected to the AIM within the vehicle.

Electronic dispenser 53 is a prior art fuel dispenser familiar to those skilled in the art. It typically accepts payment via credit or debit cards. Once payment is arranged, a user customarily activates the fueling cycle by pressing a button or lifting a lever such as pump handle 151.

In the embodiment of FIG. 1, the operation of electronic dispenser 53 has been modified by the addition of several components. AIM transceiver module 37 is mounted in a location that allows it to easily communicate wirelessly with the AIM mounted in vehicle 103. Pump control module 142 communicates with AIM transceiver module 37. The pump control module is able to automatically control the dispensing of fuel from electronic dispenser 53 once the inventive system determines that this action is appropriate.

In FIG. 2, mechanical dispenser 148 delivers the fuel to vehicle 103. The mechanical dispenser is controlled by fuel management unit (“FMU”) 72. Pump control module 181 is associated with and controls mechanical dispenser 148. AIM transceiver module 37 in this instance is mounted on FMU 72.

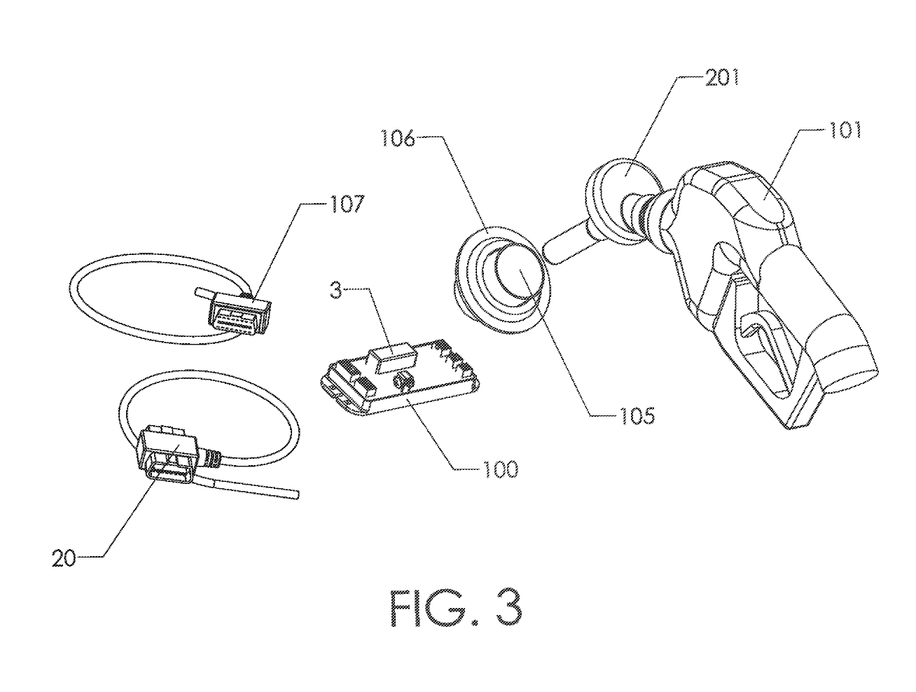

FIG. 3 shows the components of the local system that are not visible (or not very visible) in FIGS. 1 and 2. RF/ID tag 201 is mounted on fuel nozzle 101 itself. In the embodiment shown, the actual RF/ID tag is contained within a durable splash-guard-like device that actually slips over the end of the nozzle. This component is subjected to a hostile environment (heat, cold, sunlight, fuel spills, etc.) and so it is preferable to contain the RF/ID tag and associated passive or active electronics and power supply (possibly including a battery) entirely within a hardened casing. The electrical components may even be molded into this casing using a potting or overmolding process.

Fuel port 105 is the vehicle's fueling port. It leads downward into the fuel tank. As those skilled in the art will know, the fuel port is typically a metal tube that includes exclusion devices intended to prevent misfueling (such as diesel into a gasoline vehicle) and fuel theft. Fuel port antenna 106 is preferably mounted somewhere on the fuel port assembly so that it will be very close to RF/ID tag 201 when the fuel nozzle is placed in the fuel port.

Automotive information module (“AIM”) 100 is connected to fuel port antenna 106. AIM 100 uses fuel port antenna 106 to send messages to RF/ID tag 201 and receive messages from RF/ID tag 201. OBD port 107 is typically part of the vehicle's wiring harness. OBD connector 20 is connected to OBD port 107. The wiring leading from OBD connector 20 leads to AIM 100, and thereby allows communication between the vehicle's OBD bus and AIM 100. AIM 100 also includes data antenna 3. This is used primarily for communicating with the external AIM transceiver modules, but may also be used for communicating with other AIM's in other vehicles or for still other purposes.

A fueling operation will be described with respect to FIG. 1. The operator removes fuel nozzle 101 from electronic dispenser 53, moves the fuel dispenser's pump handle 151 to the fueling position, inserts fuel nozzle 101 into fuel port 105 of the vehicle's fuel tank, and dispenses fuel. In many cases, pump handle 151 need not be manually moved to the fuel position since this feature has been designed to be an automatic result of removing nozzle 101 from the dispenser's nozzle storage feature.

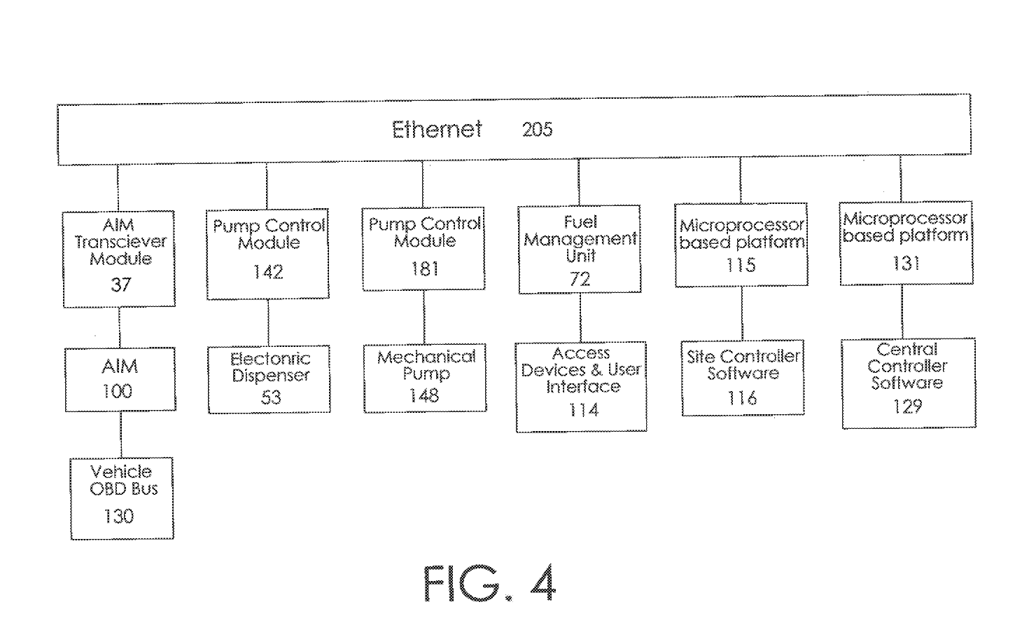

The above-described fueling procedure is identical to that normally followed when a fueling site does not include the present invention (except for the lack of a manual payment transaction). This identity is desirable since it reduces or eliminates the need for special training. The block diagram of FIG. 4 depicts come of the components involved in the present invention. The inventive system transfers, automatically and without the knowledge of the operator, vehicle 103 and RF/ID tag 201-related data from AIM 100 to site controller software 116 via AIM transceiver module 37 and Ethernet 205. The authorization steps are performed automatically and without input from the operator. Thus, in this embodiment, the operator is not aware of the payment transaction or its details. The fact that the operator's vehicle is equipped with an AIM module and stopped at an approved (and equipped) dispensing location is all the operator needs to know. He or she simply dispenses the fuel and the recording and payment transactions are handled automatically.

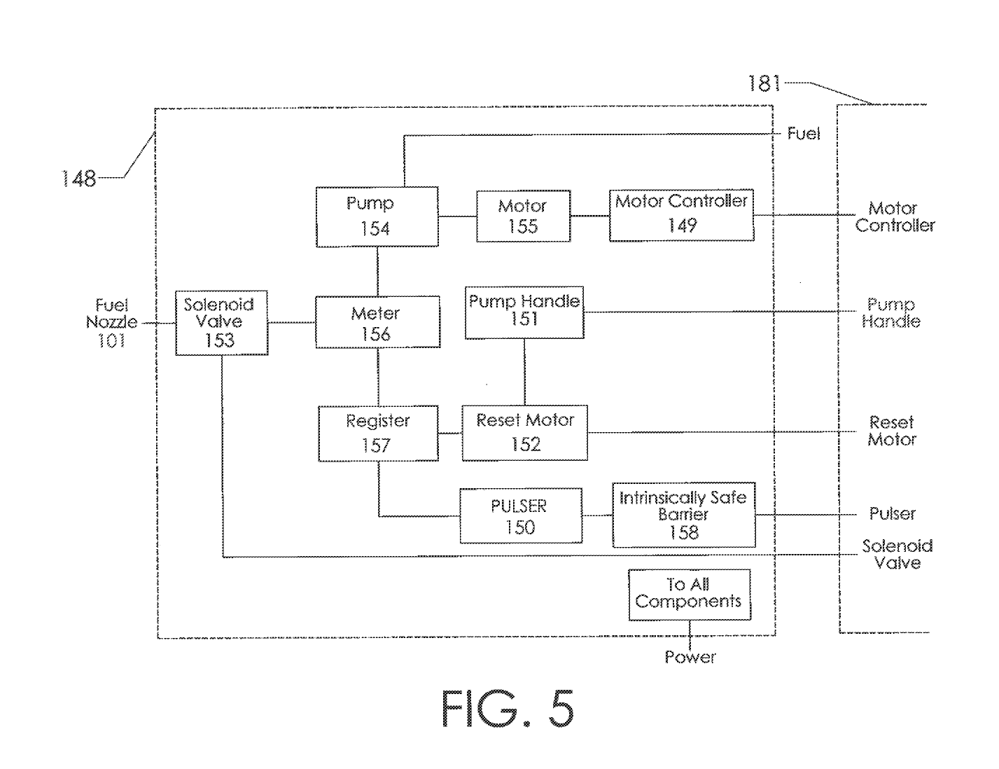

FIG. 5 shows some details for an embodiment having a mechanical fuel dispenser connected to a pump control module. In this embodiment, upon authorization by site controller software 116, authorization is transferred via Ethernet 205 to Pump Control Module 181. The pump control module then authorizes the fueling sequence by allowing mechanical dispenser 148 to be activated, and commences to monitor and record the fueling sequence as a fuel transaction. The vehicle-related data stored within the AIM's internal memory and data retrieved from the vehicle's Onboard Diagnostic Bus 107 via the AIM's Onboard Diagnostic Bus connector 20 is transmitted to AIM transceiver module 37. In the operation described the vehicle-specific data is transferred incident to a fueling operation. However, this need not always is the case. Vehicle-related data can be transferred any time the vehicle 103 is within RF range of AIM transceiver module 37.

At the completion of the fueling, Pump Control Module 142 automatically terminates the transaction, and transfers the transaction data via Ethernet to site controller software 116 where the data is stored for further processing. For example, the further processing may include transfer to off-site, remotely-located software for record keeping, invoice processing purposes.

In a dedicated fleet fueling station such as shown in FIG. 2, the Fuel Management Unit (“FMU”) may performs many functions on site (data logging, authorizing, etc.). In the public-use fueling station of FIG. 1, however, the functions of the FMU may be split among various other components (including offsite data logging devices). However, the function of the system as a whole remains quite similar. In fact, one could implement any of the functions of the public-use site for the fleet fueling site and vice-versa.

In greater detail, the operation of the preferred embodiments of the public-use system in accordance with the disclosed invention is as follows:
a. Each vehicle to be fueled is physically equipped with an AIM;
b. Each fueling site is equipped with AIM transceiver module 37 which is in turn connected to other components—such as by the use of Ethernet 205;
c. Electronic dispenser 53 is equipped with Pump Control Module 142 which may be connected via Ethernet 205 or some other method to AIM transceiver module 37;
d. Preferably each nozzle 101 on fuel island 102 is physically equipped with an RF/ID tag 201 (such as one embedded in a splash guard as shown in FIG. 3);
e. Configuration, authentication and reporting software is loaded on a site controller, which may be located either on-site or at a remote location;
f. Site controller software 116 is in communications with AIM transceiver module 37 and Pump Control Module 142, such as via Ethernet 205.
g. Each AIM 100 is configured with the correct Customer ID, vehicle ID, fuel type and quantity limits, initial odometer reading, and other pertinent information;
h. Each AIM transceiver module 37 is configured to pass data and other pertinent information between AIM 100 and site controller software 116 via Ethernet;
i. Each Pump Control Module 142 is configured to pass data and other pertinent information between electronic dispenser 53 and site controller software 116;
j. Alternatively, each Pump Control Module 181 is configured to accept data and other pertinent information to include dispenser hose correlation, lock-out and lock-in data lists and authorization requests and to directly control between mechanical dispenser 148
k. Additionally, AIM transceiver module 37 and Pump Control Module 142 are each preferably configured for direct communication between themselves (such as by using an Ethernet connection);
l. All site controller software 116 based databases are preferably built within the configuration and reporting microcontroller-based platform 115, and microcontroller-based platform 115 is in communication with the aforementioned modules to enable the authorization, downloading of lock-out and lock-in data lists, and the uploading of fuel transaction lists; and
m. In the prior sections, AIM 100 is used to authorize transactions. Should other access devices like electronic keys, magnetic stripe cards, RFID tags, barcodes or biometrics be needed, Fuel Management Unit 72 may also be located at a fueling island. FMU 72 may also function as a receipt or transaction printer interface and a tank level monitor interface.

When AIM 100 is in range of an AIM transceiver module, communication between the two devices is established. AIM 100 is capable of combining its internally-stored vehicle specific data with the fueling supply source data, the current vehicle mileage and/or chronometer data, and error detection data. The AIM transceiver module determines what data is to be sent and when it is to be sent. In this way, an AIM transceiver module is able to communicate with multiple AIM's on a common frequency while minimizing interference.

During normal vehicle operation, AIM 100 is not in contact with any external device (since the vehicle is traveling down the road). However, the AIM continuously records vehicle miles as accrued. The accrued mileage is sometimes measured using analog speed sensors. In other cases it may be calculated from OBD data and in still other cases it may simply be read from the vehicle's internal bus (such as a CAN bus).

An AIM's RF/ID tag interrogation circuitry is preferably only activated when AIM 100 is within RF range of FMU 72 and the vehicle is stopped with its ignition turned off. The interrogation circuitry can be activated in a variety of ways and for a variety of purposes (such a the purpose of debugging the RF/ID communications). This approach saves power by not activating the RF/ID circuitry every time the vehicle stops. AIM 100 is also able to check that the vehicle's engine is not running before activating the circuitry.

If an AIM's RF/ID tag interrogation circuitry has not initiated communications with RF/ID tag 201 after a configurable finite period of time, AIM 100 goes into sleep mode. After said configurable finite period of time has expired, the RF/ID circuitry can be reactivated by reactivating the vehicle OBD Bus, i.e. cycling of the vehicle's power causes AIM 100 to re-initiate vehicle mileage tracking and/or RF/ID tag 201 interrogation sequence.

RF/ID tag 201 will only be detected when fuel nozzle 101 (see FIG. 3) is actually inserted into the vehicle's fuel port. Once the detection is made, AIM 100 transmits a “hose inserted” message which includes the nozzle tag number. When requested by an AIM transceiver module AIM 100 continues to transmit the “hose inserted” message to AIM transceiver module 37 until AIM transceiver module 37 makes an acknowledgement. AIM 100 will continue its interrogation of RF/ID tag 201. Should RF/ID tag 201 not be found after a finite period of time, AIM 100 terminates both searching for, and transmitting acknowledgment of, RF/ID tag's 201 presence. When AIM 100 no longer responds to AIM transceiver module 37 queries relative to the presence of RF/ID tag 201, the site controller software will terminate the fueling transaction.

During normal operations, using its RF transceiver circuitry, AIM transceiver module 37 preferably initiates a series of communication commands. For example: There is a command sent to each individual AIM 100 to make sure that it is still present. There is also a command to have all AIMs 100 which have not been recognized by AIM transceiver module 37 respond, and a command requesting that every AIM 100 requesting fuel to respond with fueling request data. Via these commands AIM transceiver module 37 is able to track all AIMs 100 within its RF transceiver's range. AIM transceiver module 37 can then in turn go to each AIM 100 to determine if firmware updates are needed, determine if vehicle specific data needs to be gathered via the vehicle's OBD port 107, send messages to either AIM 100 or the vehicle's onboard computer via the vehicle's OBD port 107, and initiate the exchange of data based on the prior queries.

Using the aforementioned, AIM transceiver module 37 and AIM 100 conduct three major categories of data transfer: fueling operations, updating the firmware code of AIM 100, and transfer of vehicle specific data obtained via the OBD port 107. Each of these will be explained in more detail in the following.

Fueling operations: Upon receiving a response to a query transmission from AIM 100, AIM transceiver module 37 checks the received data against internally-stored data, including but not limited to fueling Customer ID, and forwards the received data including the Customer ID, and fuel dispensing hose nozzle RF/ID tag 201 number, to Site controller software 116 via Ethernet 205. The received data is verified by Site controller software 116 against the appropriate lock-out and lock-in list data. If the data is correctly verified and authorized, an authorization sequence from site controller software 116 to Pump Control Module 142 will begin (via Ethernet 205). Pump Control Module 181 being in communication with electronic dispenser 53 or in control of mechanical dispenser 148 will allow the relevant dispenser to initiate a fueling scenario.

If all selection criteria are correct and Pump Control Module 181 is wired to control the mechanical dispenser 148 directly, Pump Control Module 142 checks that the pump handle is turned on (optional), initiates a transaction, turns on the appropriate fuel dispenser hose, counts pulses equating to fuel quantity dispensed, and monitors RF reception for continuing data from AIM 100 via AIM transceiver module 37 indicating nozzle 101 is still inserted into the vehicle's fuel port 105.

If all selection criteria are correct and Pump Control Module 142 is wired to control electronic dispenser 53 via a serial data line, as would be the case for an electronic dispenser via its serial connection, Pump Control Module 142 will instruct electronic dispenser 53 to dispense fuel and to monitor the quantity. Upon removing the Nozzle 101 from the fuel port AIM 100 will no longer respond to queries from the site controller software and the site controller software will terminate fueling transactions for that AIM 100. Upon receiving a terminate transaction notification from the site controller software, AIM transceiver module 37 will forward the terminate transaction notification to Pump Control Module 142, whereby Pump Control Module 142 will via its serial control instruct the electronic dispenser 53 to terminate the transaction and to send the fuel quantity data to the Pump Control Module 142.

Pump Control Module 142 terminates the fueling sequence upon a failure to receive the continuing data notification from AIM 100 via AIM transceiver module 37, receiving a hose removed notification from AIM 100 via AIM transceiver module 37, the attainment of an internally programmed time limit, or the attainment of a pumped quantity limit.

Upon termination of the fueling sequence, Pump Control Module 142 logs a transaction record within its memory and forwards this record via Ethernet 205 to site controller software 116 for storage and data processing. If all selection criteria are not correct, no fuel is dispensed.

If Site controller software 116 determines AIM 100 software code and/or data needs updating, site controller software 116 will send the new code and/or data to AIM 100 via AIM transceiver module 37, whereby AIM 100 will do an internal update. The sending of new code and/or data can be accomplished over multiple sessions. The AIM stores the new code and/or data and is able to process the new code and/or data once the complete information has been successful transferred.

AIM transceiver module 37 is capable of two-way communication with AIM 100 whereby AIM 100 will return to AIM transceiver module 37 internally stored or vehicle-specific data obtained on demand via the vehicle's OBD Port 107. The transmitted data may have been gathered by AIM 100 autonomously or when requested by the AIM transceiver module 37. Additionally both AIM transceiver module 37 and AIM 100 can use their communications capability to have the vehicle's computers display information on the vehicle's instrument panel (such as a message displayed to a driver).

The aforementioned operational scenario is an outline of the actual events used to generate the sequence of events. Operation of the disclosed system is, however, autonomous and conducted without participation by the individuals using the fuel facilities.

Some block diagrams describing specific embodiments may benefit the reader's understanding. Referring to FIG. 4, a preferred embodiment of the disclosed system comprises sets of modules each networked via Ethernet 205 (or other suitable communication protocol). The communication may be conducted using Local Area Networks (LAN) and Wide Area Networks (WAN). Within modules, USB, 12C and serial communication protocols are used as are direct solid state and mechanical relay control.

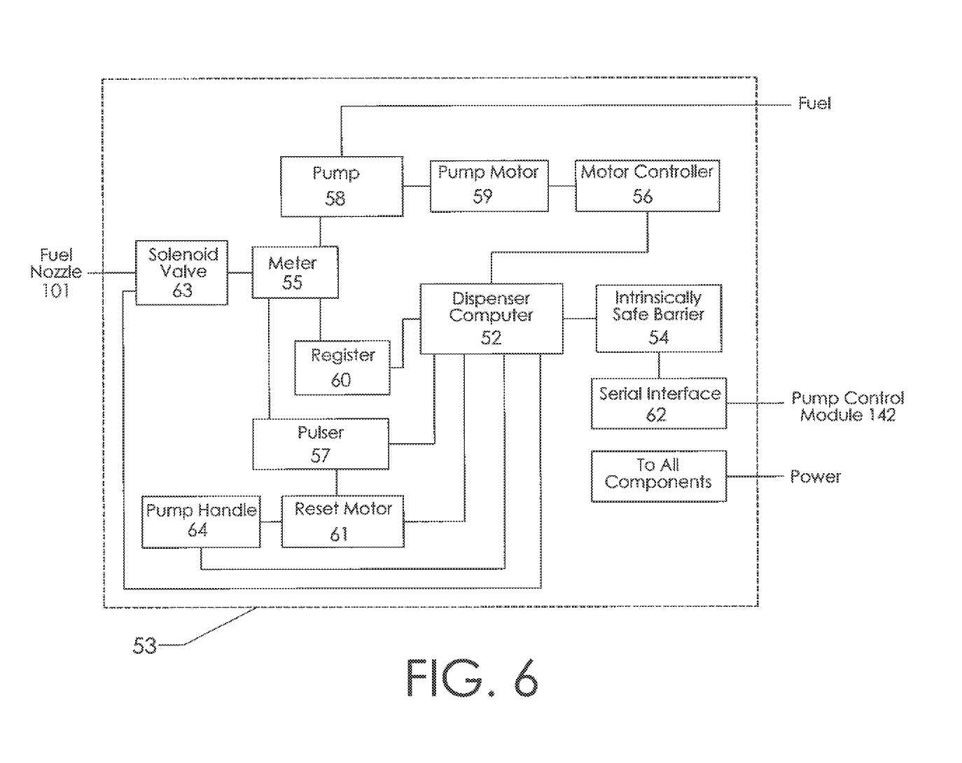

There are numerous types and variations of commercial Mechanical Dispenser 148 and electronic dispenser 53 currently available. FIG. 5 depicts a block diagram for a generic mechanical dispenser 148 comprising motor 155, a motor controller 149 and solenoid valve 153. Pump Control Module 142 is configured to interface with different types and variations of dispensers including, for example: (1) mechanical dispenser 148 with only motor 155, wherein Pump Control Module 181 controls motor 155 directly; (2) mechanical dispenser 148 with both motor 155 and motor controller 149, wherein Pump Control Module 181 controls the motor controller 149; (3) mechanical dispenser 148 with solenoid valve 153 located in the fuel line, both with or without motor 155 and/or motor controller 149, wherein Pump Control Module 142 controls solenoid valve 153; and (4) mechanical dispenser 148 equipped with a microcontroller-based control unit (herein after known as electronic dispenser 53), wherein Pump Control Module 142 is configurable to communicate serially with the fuel dispenser's 53 microcontroller, as shown in FIG. 6, thereby bypassing the need for Pump Control Module 142 to directly control the dispenser's motor controller, and/or valve or to monitor and count pulses. These functions in electronic dispenser 53 are controlled by the dispenser's microcontroller-based controller 52. Pump Control Module 142 can exercise control over and acquired data from electronic dispenser 53 via said serial interface 62.

The generic mechanical dispenser 148 shown in FIG. 5 comprises motor controller 149, which controls motor 155 driving pump 154. Pump 154 drives fuel through meter 156, through solenoid valve 153, and on to the fuel nozzle 101. Register 157 displays the amount of fuel that passes through meter 156 and turns pulser 150 so that pulser 150's output is also proportional to the fuel passing through meter 156. Upon power application to motor controller 149 and motor 155, indirectly or directly, a reset motor 152 sets register 157 to zero and allows motor 155 or solenoid valve 153 to be activated, thereby allowing dispensing of fuel. Within the mechanics of the reset motor 152 is a pump handle 151. Pump Control Module 142 is capable of monitoring pump handle 151's position to determine fueling completion.

The generic electronic dispenser 53 shown in FIG. 6 comprises motor controller 56, which controls motor 59 driving pump 58. Pump 58 drives fuel through meter 55, through solenoid valve 63, and to the fuel nozzle 101. Register 60 displays the amount of fuel that passes through meter 55 and turns pulser 57 so that pulser 57's output is also proportional to the fuel passing through meter 55. Upon power application to motor controller 56 and motor 59, indirectly or directly, a reset motor 61 sets register 60 to zero and allows motor 59 or solenoid valve 58 to be activated, thereby allowing dispensing of fuel. Within the mechanics of the reset motor 91 is a pump handle 64, operation of which imitates a fuel scenario upon removal or returning of the fuel nozzle from/to the dispenser. Dispenser computer 52 is capable of monitoring pump handle 64's position to determine fueling scenario initiation and completion, controlling motor controller 56, serial communication via intrinsically safe barrier 54 and serial interface 62, control of reset motor 61, and interface with pulser 57.

Commercially, electronic dispensers come in all shapes, sizes, and capabilities (including both internal and external configurations). The prior description illustrates components and/or functions that are typically handled by electronic dispensers. A more general discussion of electronic dispenser functions list only two things: (1) Electronic dispensers are controlled autonomously by their electronics modules, and (2) Electronic dispensers can be controlled via their electronics modules using a networked connection. It will preferably be through this network connection that the disclosed invention will control electronic dispensers.

As per the aforementioned discussion on RF/ID tags, the complexity and capabilities of an RF/ID tag range from a very basic non-powered RF/ID tag to a complex powered RF/ID tag. The very basic non-powered tags can be comprised of as little as a simple state-machine and a tuned antenna. The more complex powered RF/ID tags can be comprised of a processor, a transceiver integrated circuit and a power supply. The distinguishing feature of all RF/ID tags is that when queried they respond with data. The disclosed invention is compatible with all types.

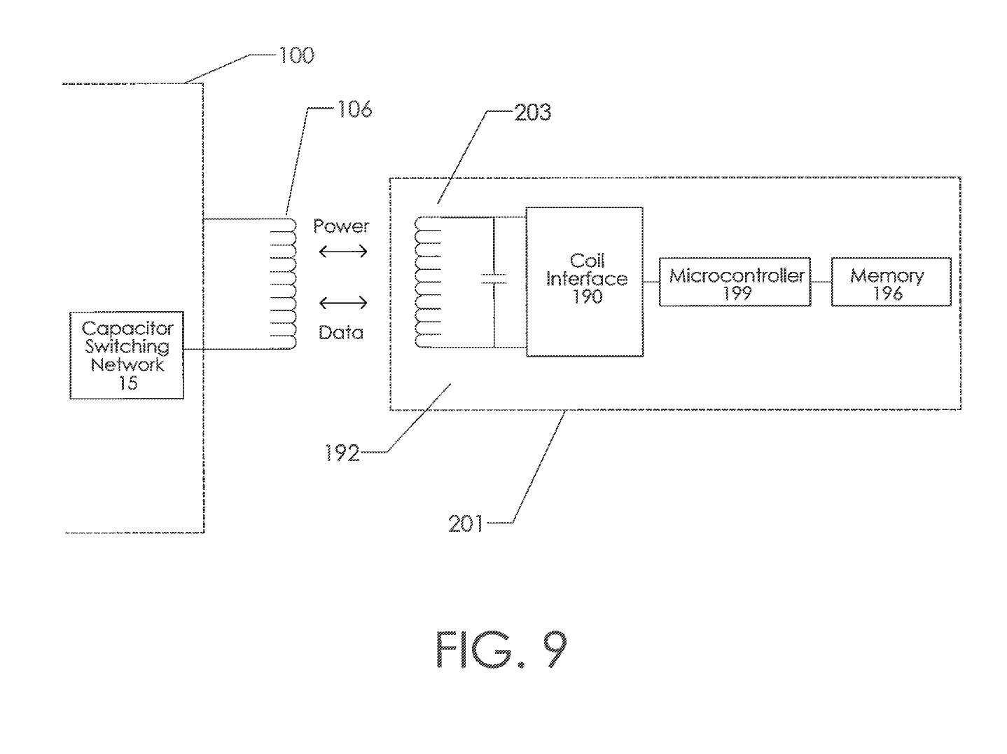

Although any of the RF/ID tags can be used by the disclosed system, FIG. 9 represents a “middle-of-the-road design.” Microcontroller 199-based RF/ID tag 201 in accordance with the disclosed system incorporates coil interface 190, microcontroller 199, memory 196, RF/ID tag antenna 203, and capacitor 192. It is mounted on the nozzle 101, preferably being incorporated into a splash guard. The receiver circuitry comprises RF/ID tag antenna 203, capacitor 192, and coil interface 190. RF/ID tag antenna 203 and capacitor 192 comprise a tuned “LC” (inductance/capacitance) circuit that creates a defined frequency for the communications. Fuel port antenna 106 and capacitor switching network 15 (both being part of AIM 100) also comprise a tuned LC circuit and the tuned frequencies of both the LC circuits need to be on the same frequency for the communication link to perform properly.

Although there are “true” RF/ID tags that would be equally compatible with the present invention, a preferred embodiment of the invention used inductively-coupled LC circuits to both transfer power for the RF/ID tag and to transfer data from the RF/ID tag to the AIM. It is also possible to incorporate a battery power source within the RF/ID tag although the currently preferred embodiment does not. RF/ID tag 201 consumes relatively little power (as the transmission ranges are so short). Accordingly, it is possible for a single included battery to provide power to the device for 2 years, 3 years, or even more. The battery can then be replaced, or the entire unit can be designed to have a life cycle that is equal to the battery life. It is also possible to have “hybrid” versions where some operating power is received via a power antenna and some “supplemental” power is provided by an internal battery.

The particular RF/ID tag 201 shown in FIG. 9 operates as follows: As this embodiment of the invention uses a non-powered tag, the tag must be powered externally. Power is supplied by AIM 100's tuned LC circuit including fuel port antenna 106 and its associated capacitor switching network 15. This tuned circuit operates on the same frequency as RF/ID tag 201's tuned LC circuit comprised of RF/ID tag antenna 203 and capacitor 192. Inductive power is passed by coil interface 190 to microcontroller 199 and to memory 196.

Microcontroller 199 receives data from memory 196 and sends that data back via coil interface 190 and the LC circuit. The data is then passed to AIM 100 via the AIM's tuned LC circuit. Thus, data stored on RF/ID tag 201 is transferred to AIM 100. While microcontroller 199 is in a powered state, it runs a short data transfer. As long as the RF energy is sufficient, microcontroller 199 repeats this. Once the RF energy is gone, microcontroller 199 has no other power source and so it shuts down.

In the preferred embodiments, the tuned LC circuit used for AIM 100 is reconfigurable so that it can alter its tuning and optimize the communication between the AIM and RF/ID tag 201. In the depiction of FIG. 9, the variable LC tuning is shown as capacitor switching network 15. The operation of the tuned LC circuit will be explained in greater detail later in this disclosure. First, however, other features of the Automotive Information Module (“AIM”) will be described.

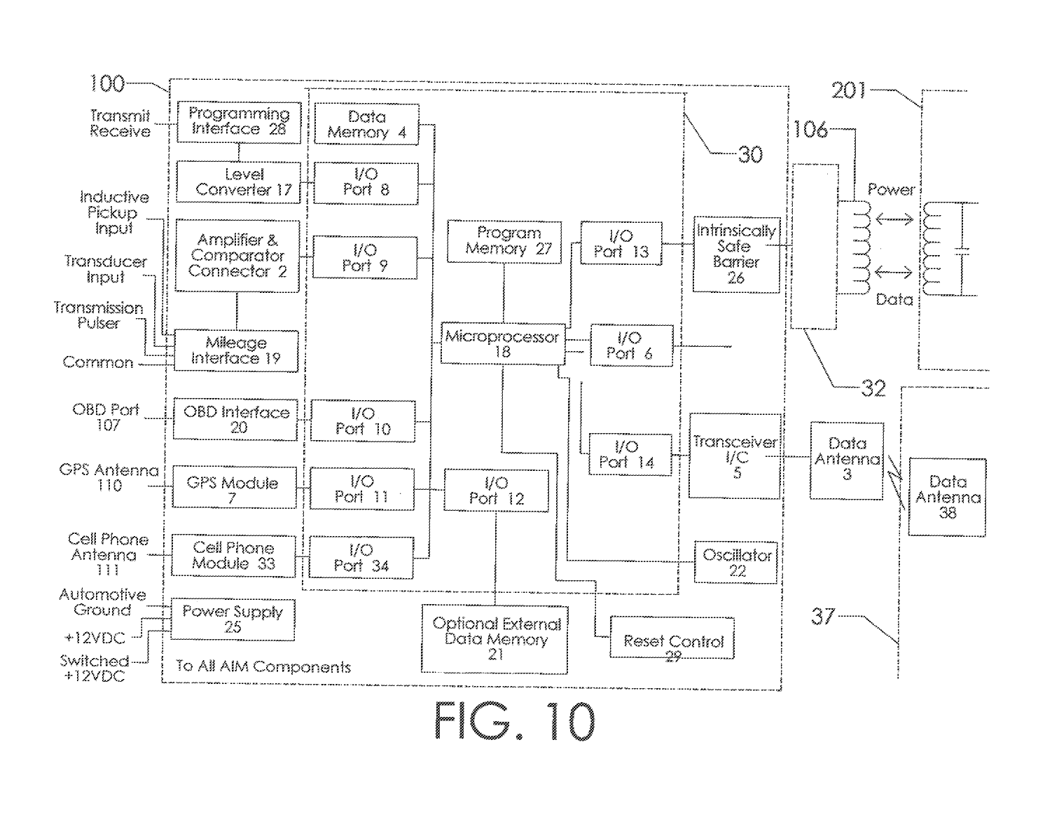

Referring to FIG. 10, microcontroller-based AIM 100 in accordance with the disclosed system incorporates RF transmitter/receiver circuitry, vehicle interface circuitry, and program logic. Microcontroller 30 incorporates a processor 18 and other associated components on a single integrated circuit. The program logic is run on processor 18. All of these functions are preferably included in a vehicle-mounted package.

The RF/ID transmitter/receiver circuitry comprises fuel port antenna 106, RF/ID interrogator 32, and intrinsically safe barrier 26. These components provide communication between microcontroller 30 and RF/ID tag 201.

Additional components are furnished to provide communication between microcontroller 32 and AIM transceiver module 37. These components are transceiver integrated circuit 5 and data antenna 3. This communication path is controlled by processor 18 through I/O port 6.

Safety requirements in and around fuel areas are driven by NFPA (National Fire Protection Association) requirements and the intrinsically safe barrier complies with these requirements. The NFPA's intrinsic safety requirements are defined by ANSI/UL 913 (Underwriters Laboratories, Inc.).

The vehicle interface circuitry may include a variety of features and preferably includes mileage interface 19 and associated amplifier and comparator 2 and I/O port 9, and power supply 25. The program logic comprises data memory 4, program memory 27, reset control 29, oscillator 22, optional external data memory 21 and associated I/O port 12, and programming interface 28 having an associated level converter 17 and I/O port 8.

When AIM 100 is installed on a vehicle without an OBD Port, AIM 100 operates as follows: Power supply 25 receives power from the vehicle, and converts and distributes the power to all required AIM 100 components. Mileage interface 19 monitors vehicle mileage. The vehicle mileage is monitored via a sine wave or a pulse count (often generated by a sensor placed on a rotating shaft) passed through amplifier and comparator 2 to I/O port 9 and to processor 18. processor 18 counts pulses (a sine wave input is converted to pulses by the amplifier and comparator 2), adds the additional mileage to the existing mileage count, and then stores the new mileage count in data memory 4. This mileage update process is carried on continuously as the vehicle generates mileage pulses as it moves.

When AIM 100 is installed on a vehicle with an OBD Port, AIM 100 operates as follows: The power supply 25 receives power from the vehicle, and converts and distributes the power to all required AIM 100 components. The AIM's 100 OBD interface 20 hardware is connected to the vehicle's OBD Port 107. AIM 100 can then acquire vehicle specific data from the vehicle computer on the vehicle's OBD Bus 130. Included in this data is the vehicle's mileage and speed information.

Programming interface 28 allows an external computer (for example, a personal computer, laptop or notebook-based computer) to initialize and input vehicle specific data. The data includes, for example, Customer ID, vehicle ID, fuel type and quantity limitations, initial mileage and pulse count to mileage conversion. This data is stored in the microcontroller's on-chip data memory 4. Programming interface 28 transfers data to and from processor 18 via I/O port 8 and level converter 17. Processor 18 contains unused I/O Port 6 for future expansion and interfaces to items such as electronic keys, magnetic stripe card readers, RF/ID tag readers, etc.

AIM 100 typically includes three communication modes: (1) RF/ID tag interrogations via intrinsically safe barrier 26 and RF/ID interrogator 32; (2) two-way communications of RF/ID tag data and vehicle-specific data to AIM transceiver module 37 via transceiver integrated circuit 5 and data antenna 3; and (3) serial communications with the vehicle's computers on the vehicle OBD bus via OBD interface 20.

In the particular embodiment shown, interrogation of RF/ID tag 201 is via processor 18 sending a transmit signal via associated I/O port 13 through intrinsically safe barrier 26 to RF/ID interrogator 32. An interrogation signal is started when the program logic determines that the vehicle has stopped and a defined time period has lapsed, or the vehicle's ignition has been turned off. The program logic discontinues the interrogation transmission upon removal of Nozzle 101 from fuel port 105, or after a programmable time period elapses without the reception of RF/ID tag 201 data.

As long as RF/ID tag 201 is receiving power via fuel port antenna 106, RF/ID tag 201 transmits data. This data is then passed to processor 18. Upon reception and successful error checking, the RF/ID tag data is stored in data memory 4. AIM 100 then proceeds with its second RF communications means, transmission of RF/ID tag ID information and vehicle specific data to AIM transceiver module 37.

The transmission of RF/ID tag ID information and vehicle-specific data to Fuel Management Unit 72 is via processor 18 receiving vehicle-specific data (for example, site ID, vehicle ID, fuel type and quantity limitations, and current mileage) and RF/ID tag ID information from the data memory 4 and sending this information to data antenna 3 via I/O port 14 and transceiver integrated circuit 5. The transmission of data by data antenna 3 is also programmable with respect to the speed, frequency of transmissions, and number of repetitions.

The communication between the AIM and the separate AIM transceiver module is facilitated by an appropriate radio frequency channel or channels. It is preferable to define multiple possible channels.

The available frequency bands and defined channels within each bands are regulated by national governments. The embodiments of the invention are preferably able to accept a variety of bands and channels so that they may comply with each individual country's regulations. Exemplary methods of communications include frequency usage, frequency-hopping schemes, and direct sequence spread spectrum signaling. In the preferred embodiments for applications within the United States, direct sequence spread spectrum signaling is used with a 2.4 GHz band and 15 channels defined within the band.

Upon the initial installation of an AIM transceiver module 37, the installation technician has the ability to select the quietest of the 15 available channels. Optionally, the AIM transceiver module may be configured to autonomously select the quietest available channel. Different AIM transceiver modules will often use different ones of the 15 available channels.

AIMs do not initiate communications. Instead, they monitor one of the 15 defined channels within the 2.4 GHz band. If the AIM receives a communication asking for a response it will respond. If an AIM is at a fueling station and is in communication with an RF/ID tag but has not received a communication from an AIM transceiver module, then the AIM will scan the 15 defined communication channels until it detects a transmitting AIM transceiver module. In the case where an AIM detects more than one AIM transceiver module the AIM will continue to scan the channels until it identifies an AIM transceiver module that is in communication with the particular RF/ID tag that the AIM is also communicating with.

Processor 18 is programmed (via program memory 27) to continue interrogating RF/ID tag 201. If RF/ID tag 201 does not respond to the interrogation, processor 18 initiates the transmission of a discontinue fueling code to AIM transceiver module 37 to ensure that fueling is discontinued if fuel nozzle 101 is removed from the vehicle's fuel port 105.

Processor 18 via I/O Port 11 and GPS Module 7 and GPS Antenna 110 has access to global positioning data (or in some instances the GPS data may be read from the vehicle data bus). Via this communications processor 18 has access to global positioning information which can be related to data received from the vehicle's on-board computers via the vehicle's OBD Port 107, OBD Interface 20 and I/O Port 10. Access to both the global positioning information and the data received from the vehicle's on-board computers by computers running the central controller software allows for generation of data and reports which link vehicle data to global position.

Processor 18 via I/O Port 34 and cell phone module 33 and cell phone antenna 111 has access to cellular communication networks. Said communications means provides processor 18 with access to intra and internet data transfer scenarios. Via this communication path global positioning data, and OBD obtained data may be autonomously transferred to intra and internet associated servers and computer platforms where it can be disseminated appropriately. The communication links being capable of both 2-way communication and data transfer allows processor 18 to receive information, instructions, and data. The cellular communication capability provides the disclosed system with both the ability to provide near real time services and the ability to have its internal operating code and parameters upgraded autonomously.

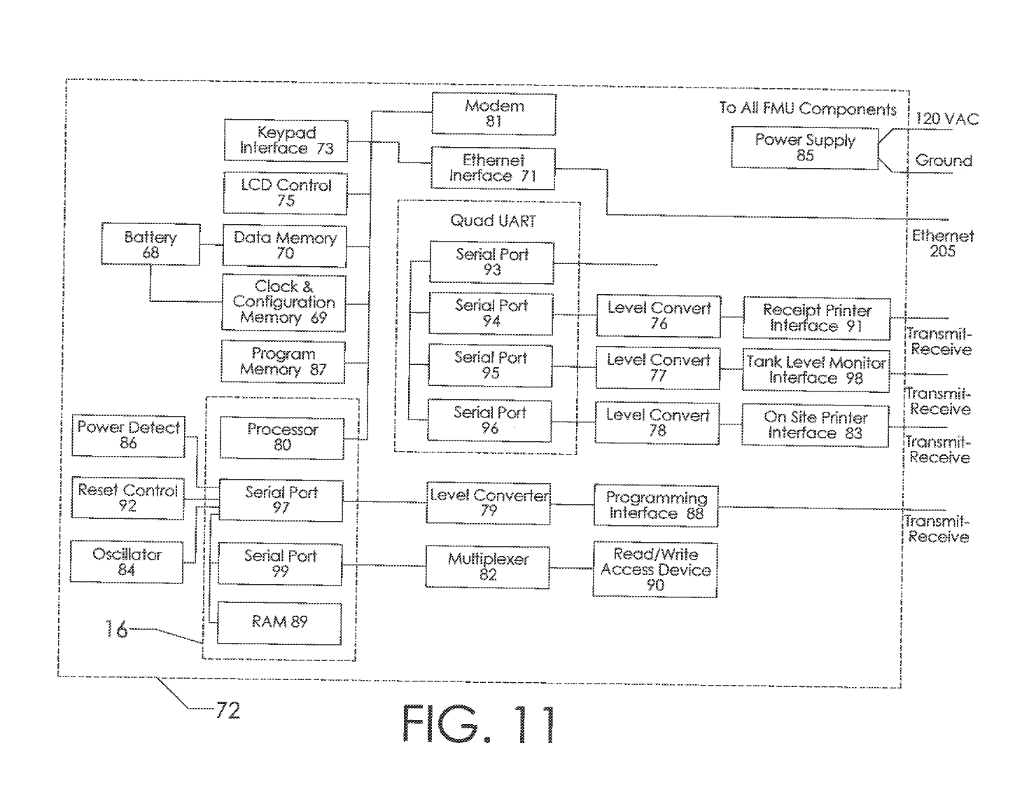

FIG. 11 depicts an embodiment of the Fuel Management Unit (“FMU”) in block-diagram form. The FMU is based on microcontroller 16, which includes processor 80. The processor incorporates processing capabilities, user and operator interface circuitry, peripheral equipment interface circuitry, multiple communication options, data storage and program logic, into a fuel island mounted package.

In some prior embodiments of the FMU features such as the AIM RF transmitter/receiver circuitry and fuel dispenser interface circuitry were integral to the FMU. In the embodiment shown, these features have been moved to independent modules. FMU 72 can still command these features, but the command is accomplished via a communication protocol such as wired or wireless Ethernet interface 71. Using this communication method FMU 72 and its internal microcontroller 16 communicate with and control AIM transceiver module 37 and Pump Control modules 181 and 142.

Operator interface components are preferably provided. Keypad interface 73, LCD control 75, and multiplexer 82 and electronic read/write key reader 90 all allow a human operator to interact with the system. An electronic read/write key reader is included in the preferred embodiments. It is also possible to include magnetic stripe card readers, RF/ID tag readers, barcode readers, Wiegand card readers, finger print readers, barcode readers and contact tag readers. The aforementioned readers are accessed by microcontroller 16 via multiplexer 82 and serial port 99.

The peripheral equipment interface circuitry comprises receipt printer interface 91, tank level monitor interface 98, on-site printer interface 83, level converters 76-78 and serial ports 94-96. The remote communications interface comprises modem 81 and Ethernet interface 71.

The program logic comprises data memory 70, program memory 87, reset control 92, oscillator 84, powerfail detect 86, clock and configuration memory 69, battery 68, and programming interface 88 with an associated level converter 79 and serial port 97.

In operation, FMU 72 receives data from AIM 100 via AIM transceiver module 37, Ethernet 205, and Ethernet interface 71. The received data is stored in data memory 70 and portions of the received data are compared with authorization data also stored in data memory 70. Upon successful verification that the fueling Customer ID, the vehicle ID, the RF/ID tag ID and the fuel type of the received data matches the authorization data and the hose is available, microcontroller 16 authorizes fuel dispensing for the hose matching the RF/ID tag ID to dispense fuel via Ethernet Interface 71, Ethernet 205, Pump Control Module 181 and or 142 for Mechanical and electronic dispensers, respectively.

The disclosed system includes an optional fuel accounting system based on an electronic read/write key activated system whereby the user and/or each vehicle is issued the electronic read/write key, and with the electronic read/write key, a user has access to fuel. These electronic read/write keys have the necessary coded data, for example, to define vehicle/user ID, key number, allowable fuel types and quantity limits, vehicle mileage, mileage reasonability checks, and preventative maintenance flags. This optional fuel accounting scenario provides a system with all necessary security, control and accounting requirements for an unmanned fueling facility. As such, the present invention's operator interface comprises keypad interface 73, LCD control 75, and electronic read/write key reader 28.

Microcontroller 16 accesses read/write key reader 90 via multiplexer 82 and serial port 99. The optional interface and operating firmware and software allow the disclosed system to operate with electronic read/write keys and/or with Automotive Information Module equipped vehicles. As per a prior description of disclosed system microcontroller 16 via multiplexer 82 and serial port 99 are equally capable of but not limited to accessing magnetic stripe card readers, RF/ID tag readers, barcode readers, Wiegand card readers, and contact tag readers.

FMU 72 is configured to provide an interface with peripheral items. The peripheral items include Ethernet interface 71, receipt printer interface 91, tank level monitor interface 98 and on-site printer interface 83. The peripheral items are controlled by microcontroller 16 via serial ports 94-96 and level converters 76-78. These features allow users to receive a receipt for an individual transaction, the station operators to receive a complete print-out of all transactions and system functions, and the remote Software operators to receive reports from tank level monitors via their interface with FMU 72. The normal interface between FMU 72 and the remote Software, which usually is on a computer, is via modem or Ethernet.

FMU 72 has the provisions to communicate with other FMUs via Ethernet interface 71 and Ethernet 205. Because of the connectivity it is not required that all FMUs interface with or accomplish all tasks. Tasks such as tank level monitoring interface, on-site printer interface, and modem 81 connectivity may be allocated to a single FMU. When one FMU is allocated tasks for a group of FMUs the FMU in question is referred to as the “master” FMU. FMUs operating with reduced connectivity and interface features are usually referred to as “satellite” FMUs. An example of this would be a multiple FMU site where the master FMU was configured to act a central communications point for the entire site's FMUs. This feature makes a remote Software program appear much more user friendly.

Communications with FMU 72 can be accomplished via Ethernet interface 71 and Ethernet 205, via modem 81 or via programming interface 88 via level converter 79 and serial port 97. One method of communication employed by the operators of the remote accounting and invoicing program is via modem 100. A second and higher speed method for said communications employed by the operators of the remote accounting and invoicing program is via Ethernet interface 71 and Ethernet 205. FMU 72 can be accessed via programming interface 130 with associated level converter 93 and serial port 88, to allow on-site trouble shooting of FMU 72 via an external computer such as a PC laptop or a notebook. Another method of communication could use the Internet, with communications over the Internet preferably being in a secure form that is decrypted using some type of key.

Upon application of power, FMU 72's power supply 85 monitors the line voltage to ensure that it is within prescribed limits and that the voltage is stable within the limits. Upon meeting the prescribed limits, voltage is then passed on to FMU 72. Upon receiving power, microcontroller 16 completes an initialization process. The initialization process, in accordance with FMU's 72 operational code, is read from program memory 87, and clock and configuration memory 69. If the line voltage becomes unstable, powerfail detect 86 issues a signal to microcontroller 16 and the microcontroller terminates any fueling transactions, stores the transactions in data memory 70, and awaits the re-application of power by power supply 85. Upon reapplication of power microcontroller 16 will read the pertinent data relating to transactions that were in progress during the prior shutdown, complete the transaction data and stores the data in Data Memory 70.

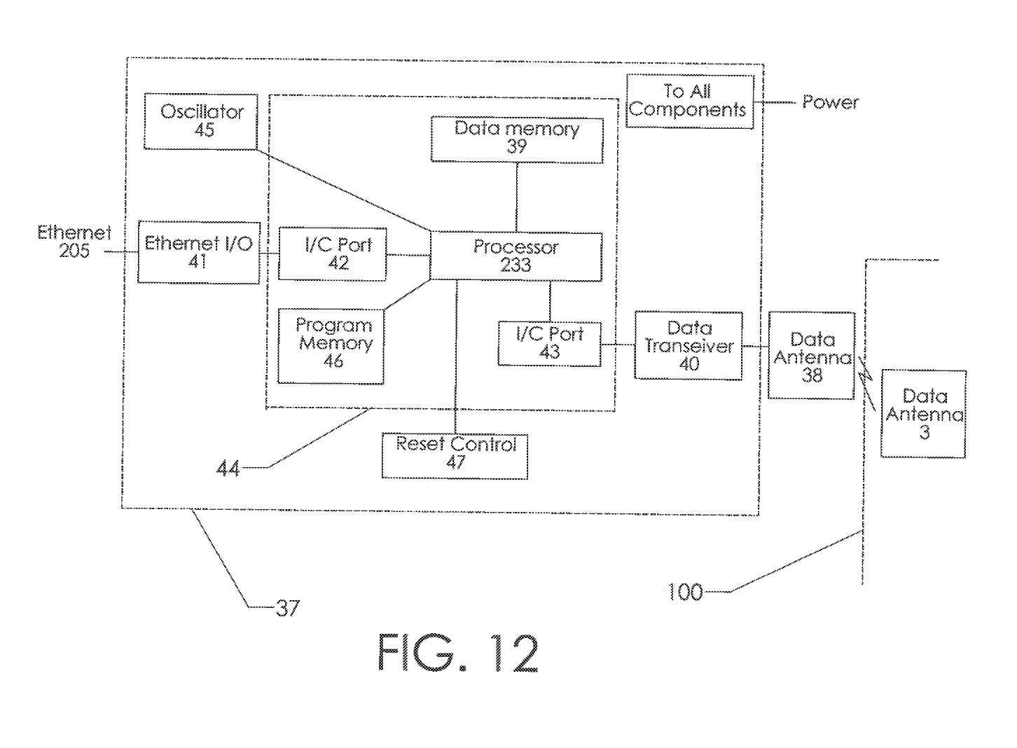

An embodiment of AIM transceiver module 37 shown in FIG. 12. This device includes a 2-way RF communication system configured to communicate with AIM 100. It is able to send information and data gathered via the 2-way RF communication equipment to either Intra and or Internet via wired or wireless Ethernet, and incorporates via a microcontroller the ability to control and provide logic via internal software to the 2-way RF communication system.

Microcontroller 44 receives, transmits and controls AIM 100 communication via I/O port 43, transceiver integrated circuit 40, and data antenna 38. Microcontroller 44 is able to control and provide logic via internal software stored in program memory 46 and data storage 39. Microcontroller 44 communicates over the intra and or internet via I/O Port 42, Ethernet I/O 41 and Ethernet 205.

The preferred embodiments include an “auto-tuning” feature for optimizing the R/F link between the AIM's fuel port antenna and the RF/ID tag incorporated in the fuel nozzle. Returning briefly to FIG. 3, the reader will recall that the communication between the AIM located in the vehicle and the RF/ID tag located in the nozzle assembly is preferably a short range link. Fueling should only be authorized while the nozzle remains in place within the vehicle's filler port. The AIM continually monitors for the presence of the nozzle in the port by transmitting signals using fuel port antenna 106. RF/ID tag 201 receives these signals and sends an appropriate response. The AIM receives this response and thereby “knows” that the nozzle has not been removed.

The communication range between fuel port antenna 106 and RF/ID tag 201 is preferably limited to less than 1 meter and even more preferably limited to less than 0.17 meters (less than 6 inches). That way, if an unscrupulous operator attempts to remove the nozzle from an authorized vehicle and deliver fuel to an unauthorized vehicle, the communication link will be broken and fueling will be stopped. On the other hand, the communication link needs to be robust and reliable so that erroneous “stop fueling” messages are not created. The reader will thereby appreciate that the communication link in question preferably has the following two goals: (1) a very short range, and (2) a very high reliability. Those skilled in the art will realize that these two goals are largely contradictory and that the design of such a system requires careful consideration.

Still looking at FIG. 3, those skilled in the art will realize that the performance of fuel port antenna 106 varies depending upon the type of vehicle on which it is installed. This variation depends largely upon the ferromagnetic characteristics of the surrounding materials. As an example, if fuel port antenna 106 is placed around a cylindrical steel fuel port the fuel port material will inductively couple with the loop. Other steel or iron objects in close proximity will have a similar effect. The structure of other vehicles may be largely aluminum. Still other vehicles may include composites that do not inductively couple in the R/F link to the same degree that ferromagnetic materials do.

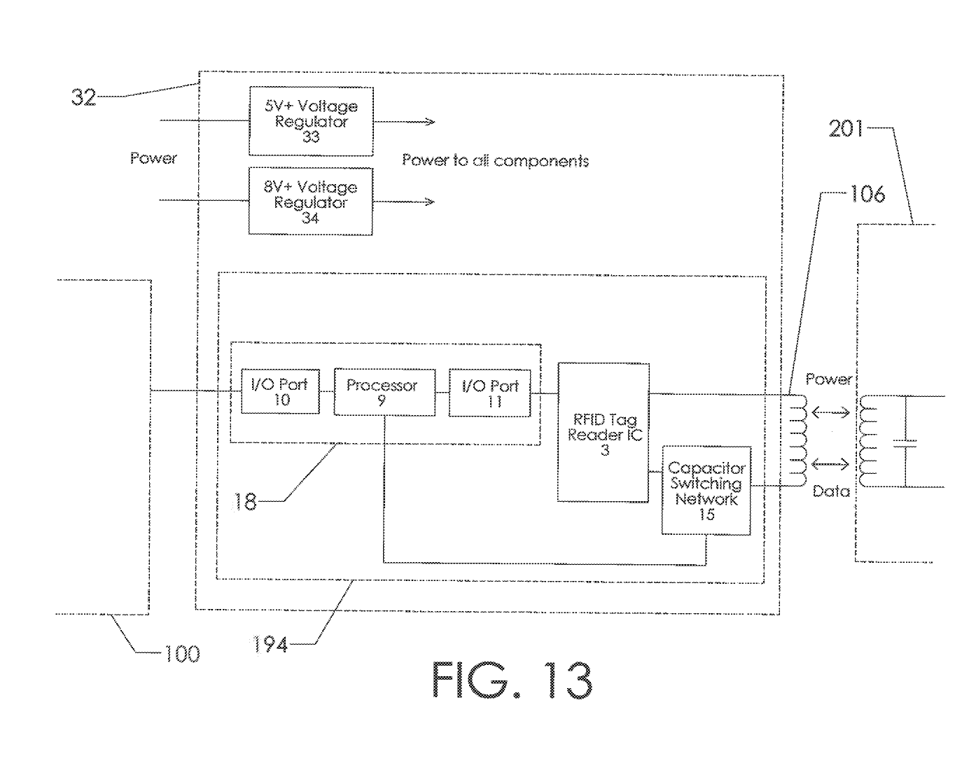

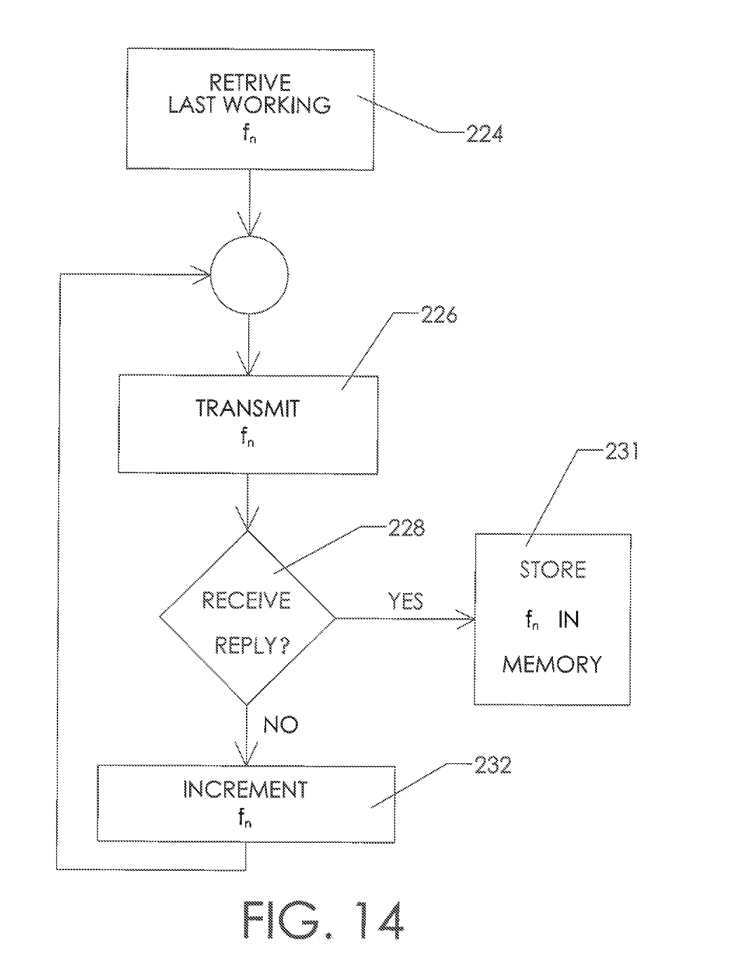

It is not desirable to change the physical structure of fuel port antenna 106 itself. Thus, it is preferable to “tune” the antenna by changing the driving circuitry. The two aforementioned goals (short range and reliability) make a single tuning unlikely to work well for all vehicles. A configuration that is optimum for one vehicle may produce either too much range or too little range (and therefore marginal reliability) on another. It is preferable to provide a solution allowing each vehicle to be tuned individually. FIGS. 13-14 describe an embodiment configured to provide vehicle-specific tuning.

Returning now to FIG. 10, the reader will recall that AIM 100 communicates with RF/ID tag 201 using RF/ID interrogator 32. In the disclosed embodiment, the antenna tuning components are contained in the RF/ID interrogator. FIG. 13 shows an exemplary diagram of RF/ID interrogator 32. LC tuning circuit 194 includes microcontroller 18, RF/ID tag reader integrated circuit 3, and capacitor switching network 15. These components cooperate to (1) communicate with RF/ID tag 201, and (2) tune the AIM's LC circuit. The AIM's LC circuit includes fuel port antenna 106 in combination with the vehicle's unique inductive and capacitive characteristics. In other words, the AIM's LC circuit exists as it is installed in a particular vehicle.

Capacitor switching network 15 is capable of switching in and out selected series and parallel capacitors so that a selected total capacitance is placed in series with fuel port antenna 106. The fuel point antenna is the inductive part of the tuned LC circuit and the selected capacitor or capacitors is the capacitive part of the circuit. The result is that the resonant frequency of the LC circuit is varied as desired. Processor 9 selects the capacitance and switches within capacitor switching network 15 are switched to produce that capacitance. LC tuning is performed until communication is established with RF/ID tag 201. Two way information flow is via AIM 100's intrinsically safe barrier, through I/O port 10, to processor 9, through I/O port 11, through RF/ID tag reader integrated circuit 3, and finally to fuel port antenna 106.

There are certainly other ways to tune and optimize an LC circuit and the approach of switching in and out various capacitors is properly viewed as only one way. One could also switch in and out differing inductors and one could also use variable capacitors or variable inductors. Whatever approach is used, a goal is to match the tuned frequency of RF/ID tag 201.

A transmitter circuit driving an antenna is generally idealized as an “LC” circuit, meaning that the inductance and/or capacitance of the circuit is varied to produce the desired frequency. It is recognized that all the components in the circuit have some resistance, and that one may therefore properly call this an “LRC” circuit. However, since inductance and capacitance are the phenomena of primary concern, it will be called an “LC” circuit.

The interrogation circuitry is activated by AIM 100 via I/O port 10 and processor 9. The power and receiver circuitry is inductively coupled to fuel port antenna 106 via RF/ID tag reader integrated circuit 3 and capacitor switching network 15. Capacitor switching network 15 includes capacitors and switches arranged so that differing combinations of the switches can produce a number of differing capacitances. Preferably different branch circuits are provided so that the same capacitors can be arranged in series or parallel to produce a large number of overall selectable capacitances. Processor 9 will selectively sequence the capacitor switching network through various capacitances until communication is established with RF/ID tag 201.

The present invention determines an optimized frequency through trial and error. The general process may be described as follows:

1. A starting query frequency is retrieved from memory and sent via RF/ID interrogator 32;

2. RF/ID tag reader integrated circuit 3 and processor 9 in combination monitor for a response from the RF/ID tag on the reply frequency;

3. If no response is received, the starting query frequency in incremented to a new value and a new signal is sent by RF/ID interrogator 32;

4. Once RF/ID tag reader integrated circuit 3 and processor 9 receive a good response from the RF/ID tag on the reply frequency, the transmitter frequency used to elicit that response (which will be the last-transmitted query frequency) is stored as a “known good” frequency for that particular installation (and becomes the “starting query frequency” the next time the cycle is run);

5. The next time a fueling operation is commenced, the last saved “starting query frequency” is used at the outset;

6. If the last “starting query frequency” frequency fails to elicit a response the transmitter frequency is incremented again until a response is received and the successful frequency is then saved as the new “known good” frequency.

Once a reply is received, the R/F link between the transmitter and the RF/ID tag is deemed established. As explained previously, the establishment of this link is used as a trigger to commence the fueling cycle. The dispenser nozzle is activated and fueling can commence. As also explained previously, the R/F link continues during the fueling operation. The transmitter continues to send the query signal and the system continues to monitor for the reply signal. If a reply signal is not received at any time, a signal is generated by the AIM which terminates the fueling process (via the other components described previously).

Optionally, one could configure the system to search for a new “good” transmitter frequency upon the loss of the reply signal. Since running through the available frequencies typically takes less than one second, a search can be conducted without significantly compromising the security of the fueling operation. In this embodiment fueling would not be terminated until all transmitter frequencies had been tried without receiving a reply.

Obviously one could choose to increment the transmitter frequency in many different ways. In the preferred embodiment, a band of possible frequencies is defined. The search process commences at the bottom of this band. The increment is then stepped up in a positive direction. One could also start at the top of the frequency band and increment in a negative direction. One could also start in the middle of the frequency band and increment in either direction. It is preferable to have the system repeat the process so that if it reaches the top of the band with no success it either starts going back down the band or rolls over to the bottom of the band and starts anew.

One could also have a random selection process that would randomly distribute among the available frequencies until all had been tried. Each “tried” frequency would then be removed from the pool of remaining frequencies and a new frequency randomly selected from those that remain.

FIG. 14 shows a flow diagram of the process in one embodiment. The process starts by retrieving the last starting query frequency from memory (step 224). This frequency is then transmitted in step 226. Step 228 asks whether a reply has been received from the RF/ID module in the nozzle. If “yes” then the starting query frequency is stored again in memory (step 231). If “no” then the frequency is incremented by a defined increment and the process is repeated.

This simple system does not seek to optimize the tuning but rather only seeks a tuning that works at the particular time it is tested. Once a working frequency is found, the tuning process ends and the normal fueling authorization process proceeds. If that frequency proves to be marginal and fails on the next fueling operation, then the incrementing process is started anew and a better frequency will be found and saved.

In this way, an optimum frequency will be found for each particular installation of an AIM in a particular vehicle. The optimum frequency may not be found on the first fueling operation, but a working frequency will be found. Over several iterations, the optimum frequency is likely to be found and saved. This frequency is then no likely to change much for a particular installation in a particular vehicle. Using the microelectronics described previously, the entire tuning operation can be completed in less than one second.

Of course, in other embodiments, it may be desirable to find the optimum frequency in a single cycle. In order to do this one would need to sample the strength of the return signal from the RF/ID module. There are numerous available components capable of sampling the strength of the return signal. One could then program the variable frequency transmitter to step through its entire range while signal strengths are measured and recorded. One could then compare the results and select the best frequency.

The actual signaling protocol used in the R/F communication link is not critical. One could employ an interval-based protocol, a frequency shift-based protocol or some other approach. As explained in the preceding sections, the transmitter transmits a signal to the R/F identification tag on a first frequency and the tag typically responds on a second frequency. The first frequency is referred to as a “query frequency” and the frequency used by the R/F identification tag for a response is referred to as a “reply frequency.”

In some embodiments these two frequencies may actually be the same. In those cases, the transmitter may transmit for a fixed interval and then go “silent” for a fixed interval so as not to interfere with the detection of a reply. This approach can be cumbersome and, accordingly, the use of two separate frequencies is preferred.

It is not desirable to have the transmitter continuously transmit the “query” signal whenever the vehicle is in operation. After all, the query signal only serves a purpose when the vehicle is close to a fueling station. As explained previously, the signal cycle is initiated when the AIM established communication with the AIM transceiver 37 located proximate a fueling station. This link between the AIM and the AIM transceiver serves as a “proximity detector” between the vehicle and the fueling station. May other types of “proximity detectors” could be used. For example, various vehicle detectors could be placed on the fueling station and used to trigger a radio signal to the AIM in the vehicle. Ultrasonic and magnetic detectors could be used. Also, a simple RF/ID module could be placed in the vehicle that responds to a query signal transmitted by the fueling station. All of these devices serve the “proximity detector” function and may be used to start the transmission cycle from the AIM in the vehicle to the RF/ID tag on the nozzle.

The reader will appreciate that a particular Fuel Management Unit (whether comprising a stand-alone device at a fleet fueling system or a combination of devices at a public-use station) may be in contact with more than one AIM. This is particularly true of the fleet-fueling scenario, where a single FMU might be in contact with three or more AIMs. Multiple FMU's may in fact be present and this further complicates the communication system.

In addition, there are multiple types of messages that have to be passed between an AIM(s) and an FMU(s). Some message types are more important than others, depending on the context. For instance, one message type might pertain to vehicle maintenance while another might pertain to continued authorization of an ongoing fueling event. One would generally not want the former type to override the latter.

In a preferred embodiment of the inventive system, eight cycles are used and within each of these cycles there are four different data type communication requirements. Some message types are transferred during each of the cycles whereas other message types are transferred less frequently. The inventive system uses a communication protocol based on the priority given to each specific type of message.

The reader will recall that each AIM is installed in a vehicle and is intended (among other things) to establish an R/F communication link with an RFID tag located on a fueling nozzle. The existence of that communication link is required to allow fuel dispensing and the maintenance of that link is required to continue fuel dispensing. Thus, monitoring the status of that link is a large priority in the system. There are certainly other priorities, however, such as the transfer of vehicle-specific data (mileage, oil status) from an AIM to an FMU.

The different types of communications are conducted in a defined order during each cycle. The following numbered paragraphs describe the communication types in their order of priority:

1. Primary Status Poll—When any AIM has previously informed the FMU that it has established a communication link with a nozzle-mounted RFID tag, the FMU will send out this poll asking whether the AIM is currently still reading the presence of the nozzle-mounted RFID tag. If the nozzle is still being read then the AIM will respond positively. If the AIM responds negatively, or if the AIM fails to respond through a certain number of cycles, then the fueling operation will be stopped by the FMU. This functionality is very important to the present invention and for this reason it is preferably given priority.

2. Secondary Status Poll—This message is sent by the FMU when an AIM has been previously registered as being in range. The message is sent no matter what state the AIM is in. The AIM's response simply informs the FMU that the AIM is still in communicating range. If a particular AIM fails to respond after a specified number of these messages then it will be eliminated from the list of enumerated AIMs.

3. AIM Enumeration Request—An FMU sends this request seeking to establish communication with any AIMs within range of the FMU. If an AIM successfully responds, then that AIM is considered to be enumerated to the FMU (registered as currently active).

4. Hose Enumeration Request—An FMU sends this request to determine if any of the enumerated AIMs have a newly-established communication link with an RFID tag on a dispenser nozzle (indicating that a dispenser nozzle has just been placed within a fueling port). If an AIM positively responds to this request, then the FMU takes appropriate action (initiating a dispensing operation).

5. Data Exchange—Bidirectional data exchanges take place between the FMU and the AIM. These are generally prioritized as follows: (1) Sending the AIMs record to the FMU, (2) Sending miscellaneous data from the AIM to the FMU, (3) Sending an AIM record update from the FMU to the AIM, (4) Sending miscellaneous data from the FMU to the AIM, (5) Sending AIM pass-through data, (6) Sending automatic AIM firmware data.

An FMU's communication with AIM devices is based on 8 cycles, each of which is approximately 2 seconds long. After a particular cycle expires, communication moves to the next cycle. When the 8^{th} cycle is repeated, the process starts over with the first cycle. The following table shows an exemplary ordering of the data transferred. Time proceeds from left to right in the particular embodiment shown. An “X” indicates when each message type is transmitted.

TABLE ONE

| | | | AIM | Hose | |
|---|---|---|---|---|---|
| | Primary | Secondary | Enumeration | Enumeration | Data |
| | Status Poll | Status Poll | Request | Request | Exchange |
| Cycle 1 | X | | X | | X |
| Cycle 2 | X | | X(If AIM | X(If AIM | X |
| | | | present) | present) | |
| Cycle 3 | X | X | X | | X |
| Cycle 4 | X | | X(If AIM | X(If AIM | X |
| | | | present) | present) | |
| Cycle 5 | X | | X | | X |
| Cycle 6 | X | | X(If AIM | X(If AIM | X |
| | | | present) | present) | |
| Cycle 7 | X | X | X | | X |
| Cycle 8 | X | | X(If AIM | X(If AIM | X |
| | | | present) | present) | |

The reader will therefore appreciate that the embodiment described provides a prioritization of the available traffic. It is possible to provide other prioritization schemes, but the scheme described provides a high priority to critical items (ensuring security of the fueling process) and a lower priority to other items that can wait (such as updating AIM firmware).

The explanations of the specific embodiments include the use of a “microcontroller.” The terms “microcontroller” and “microprocessor” are often confused in the field of electronics. In general, a microcontroller is a single chip that includes a processor and RAM, ROM, or some other component. It is generally designed to perform a specific set of tasks and—as a result—represents a cost savings. A microprocessor, on the other hand, contains a processor and possibly some other components but generally relies on external memory. A microprocessor is often more flexible, as it can be configured with differing external components and can be programmed to do different tasks. It is also generally more expensive.

In the context of the present invention, a microprocessor could be substituted for the microcontrollers actually described, though this would in many instances require adding additional components. Both devices include a processor running software. A microcontroller represents the preferred embodiments, but other types of processor-including devices could be used in the present invention.

Although a road-going motor vehicle has been used in the illustrative embodiments, the reader should recall that the system disclosed could be used with many other types of vehicles including aircraft and boats. Further, the inventive system could be used to control the dispensing of virtually any substance (whether liquid, solid, or gas) into a portable container.

The foregoing description of the preferred embodiments of the disclosed system has been presented to illustrate the principles of the disclosed system and not to limit the disclosed system to the particular embodiments illustrated. It is intended that the scope of the disclosed system be defined by all of the embodiments encompassed within the following claims and their equivalents, rather than by any particular example given.

Having described our invention, we claim:

1. A method for controlling the delivery of a substance into a container, comprising:
a. providing a container with an inlet port;
b. providing a processor having an associated memory, said processor being mounted to said container;
c. providing a variable-frequency transmitter connected to an antenna located proximate said inlet port of said container, said variable-frequency transmitter being controlled by said processor;
d. providing a dispenser configured to deliver said substance to said container via said inlet port;
e. providing an RF identification tag attached to said dispenser, said RF identification tag configured to receive a query signal on a query frequency and transmit a reply signal on a reply frequency;
f. providing a tag receiver configured to detect said reply signal from said RF identification tag, said tag receiver being in communication with said processor;
g. said processor causing said variable-frequency transmitter to transmit to said RF identification tag on a starting query frequency, and thereafter alter said query frequency through a defined range of query frequencies;
h. said tag receiver monitoring for said reply signal and, upon detecting said reply signal, informing said processor that the last-transmitted query frequency has elicited a reply signal from said RF identification tag;
i. saving said last-transmitted frequency in said associated memory as a new value for said starting query frequency;
j. after said reply signal is received, commencing said delivery of said substance through said dispenser into said container,
k. said variable-frequency transmitter thereafter continuing to transmit on said last-transmitted frequency; and
l. continuing to monitor for said reply signal and, in the event that no reply signal is received, terminating said dispensing operation.

2. A method for controlling the delivery of a substance into a container as recited in claim 1, wherein said variable frequency transmitter alters said query frequency by switching between a plurality of capacitors.

3. A method for controlling the delivery of a substance into a container as recited in claim 2, wherein said switching between said plurality of capacitors is controlled by said processor.

4. A method for controlling the delivery of a substance into a container as recited in claim 1, wherein said altering said query frequency through said defined range comprises starting with said starting query frequency and incrementing said starting query frequency by a fixed increment until it has been incremented through said defined range.

5. A method for controlling the delivery of a substance into a container as recited in claim 1, wherein said variable frequency transmitter alters said query frequency by switching between a plurality of inductors.

6. A method for controlling the delivery of a substance into a container as recited in claim 1, wherein said variable frequency transmitter alters said query frequency by altering both the capacitance and the inductance of the transmitter circuit.

7. A method for controlling the delivery of a substance into a container as recited in claim 1 wherein when said reply signal is lost during said dispensing operation, a new cycle of query frequencies is tried before terminating said dispensing operation.

8. A method for controlling the delivery of a substance into a container, comprising:
a. providing a container with an inlet port;
b. providing a variable-frequency transmitter connected to an antenna located proximate said inlet port of said container,
c. providing a dispenser configured to deliver said substance to said container via said inlet port;
d. providing an RF identification tag attached to said dispenser, said RF identification tag configured to receive a query signal on a query frequency and transmit a reply signal on a reply frequency;
e. causing said variable-frequency transmitter to transmit on a starting query frequency, and thereafter alter said query frequency through a defined range of query frequencies;
f. monitoring for said reply signal from said RF identification tag and, upon detecting said reply signal,
i. stopping said frequency altering by said variable-frequency transmitter so that said transmitter remains on the last-transmitted query frequency, and
ii. commencing said delivery of said substance through said dispenser into said container;
g. said variable-frequency transmitter thereafter continuing to transmit on said last-transmitted query frequency; and
l. continuing to monitor for said reply signal and, in the event that no reply signal is received, terminating said dispensing operation.

9. A method for controlling the delivery of a substance into a container as recited in claim 8, wherein said variable frequency transmitter alters said query frequency by switching between a plurality of capacitors.

10. A method for controlling the delivery of a substance into a container as recited in claim 9, wherein said switching between said plurality of capacitors is controlled by a processor.

11. A method for controlling the delivery of a substance into a container as recited in claim 8, wherein said altering said query frequency through said defined range comprises starting with said starting query frequency and incrementing said starting query frequency by a fixed increment until it has been incremented through said defined range.

12. A method for controlling the delivery of a substance into a container as recited in claim 8, wherein said variable frequency transmitter alters said query frequency by switching between a plurality of inductors.

13. A method for controlling the delivery of a substance into a container as recited in claim 8, wherein said variable frequency transmitter alters said query frequency by altering both the capacitance and the inductance of the transmitter circuit.

14. A method for controlling the delivery of a substance into a container as recited in claim 8 wherein when said reply signal is lost during said dispensing operation, a new cycle of query frequencies is tried before terminating said dispensing operation.

15. A method for controlling the delivery of a substance into a container, comprising:
a. providing a container with an inlet port;
b. providing a processor having an associated memory, said processor being mounted to said container;
c. providing a variable-frequency transmitter connected to an antenna located proximate said inlet port of said container, said variable-frequency transmitter being controlled by said processor,
d. providing a dispenser configured to deliver said substance to said container via said inlet port;
e. providing a proximity detector for detecting when said container is near said dispenser;
f. providing an RF identification tag attached to said dispenser, said RF identification tag configured to receive a query signal on a query frequency and transmit a reply signal on a reply frequency;
g. providing a tag receiver configured to detect said reply signal from said RF identification tag, said tag receiver being in communication with said processor,
h. upon said proximity detector detecting that said container is near said dispenser, said processor retrieving a starting query frequency from said associated memory and causing said variable-frequency transmitter to transmit to said RF identification tag on said first query frequency, and thereafter alter said query frequency through a defined range of query frequencies;
i. said tag receiver monitoring for said reply signal and, upon detecting said reply signal, informing said processor that the last-transmitted query frequency has elicited a received reply signal from said RF identification tag;
j. saving said last-transmitted frequency in said associated memory wherein said last-transmitted frequency becomes said starting query frequency;
k. commencing said delivery of said substance through said dispenser into said container,
l. said variable-frequency transmitter thereafter continuing to transmit said last-transmitted query frequency; and
m. continuing to monitor for said reply signal and, in the event that no reply signal is received, terminating said dispensing operation.

16. A method for controlling the delivery of a substance into a container as recited in claim 15, wherein said variable frequency transmitter alters said query frequency by switching between a plurality of capacitors.

17. A method for controlling the delivery of a substance into a container as recited in claim 16, wherein said switching between said plurality of capacitors is controlled by said processor.

18. A method for controlling the delivery of a substance into a container as recited in claim 15, wherein said altering said query frequency through said defined range comprises starting with said starting query frequency and incrementing said starting query frequency by a fixed increment until it has been incremented through said defined range.

19. A method for controlling the delivery of a substance into a container as recited in claim 15, wherein said variable frequency transmitter alters said query frequency by switching between a plurality of inductors.

20. A method for controlling the delivery of a substance into a container as recited in claim 15 wherein when said reply signal is lost during said dispensing operation, a new cycle of query frequencies is tried before terminating said dispensing operation.
